(19) United States
(12) Patent Application Publication
(10) Pub. No.: US 2023/0237408 A1
(43) Pub. Date: Jul. 27, 2023

(54) GENISOR OPERATIONAL AUXILIUM TOOLKIT FOR NON-FUNGIBLE ASSETS

(71) Applicant: Liquid Rarity Exchange, LLC, Clayton, MO (US)

(72) Inventor: MICHAEL SAIGH, CLAYTON, MO (US)

(21) Appl. No.: 18/095,867

(22) Filed: Jan. 11, 2023

Related U.S. Application Data
(60) Provisional application No. 62/891,328, filed on Aug. 24, 2019.

(51) Int. Cl. G06Q 10/0637; G06Q 40/04

(52) U.S. Cl. CPC G06Q 10/0637; G06Q 40/04

(57) ABSTRACT

The invention describes the Rarity Trading Platform (RTP) and ecosphere referred to as the Genisor Operational Auxilium Toolkit (G.O.A.T.) command logic, methods, system and technologies for creators of new intellectual property assets designed for immersive collaboration and networking for Non-Fungible-Assets (NFAs/NFTs) through a plurality of verified milestone product development deliverable gateways utilizing auxilium software and hardware tools for Enterprise Organization's nascent to lower startup risk for collaborating creators. In addition, RTP synchronizes vetted milestone input data with resulting resources such as capital, legal, accounting and business management software services, analytics and indexes for trading assets exchanges such as: Stock, Crypto, Metaverse and Omniverse exchanges where newly and past created assets are securely recorded, vetted and certified on the RTP through a variety of analytical models of renumeration and transcribed via milestone blockchains.

### CROSS-REFERENCE TO RELATED APPLICATIONS

This application claims priority to US provisional patent application entitled INTELLECTUAL PROPERTY NFT GENEISOR, No. 62/891,328, filed Jan. 11, 2022, the contents of which are incorporated herein by reference as though fully set forth herein.

### STATEMENT REGARDING FEDERALLY SPONSORED RESEARCH OR DEVELOPMENT

Not applicable.

### FIELD

The present disclosure relates to customized software, hardware devices and toolkits on one or more distributable platforms, ecospheres and communication networks designed for the creation of original intellectual property, enhance global collaboration, and new efficiencies through progressive milestone-based immutable cryptology collectively referred to as “Genisor Operational Auxilium Toolkit” (GOAT) of which includes, but is not limited to, various resources such as operational, back-end and front-end servers, Application Programming Interfaces (APIs), legal, capital, strategic, marketing, promotion, Human Resources (HR), accounting, Machine-to-Machine (M2M) logic and other advanced analytical and business tools, technical and foundational models and resources to significantly lower startup risk and costs associated with new product and service development throughout the product assets lifecycle and in due course traded through various financial exchanges (primary and secondary), sold and licensed to a plurality of stakeholders, investors and users.

### BACKGROUND

In the last few years, blockchain-enabled data has proliferated through a growing list of immutable records called “blocks” that are linked together using cryptography, hence, “blockchain.” Each block contains a cryptographic hash of the previous block, a timestamp, and transaction and pertinent informational data. The timestamp proves that the transaction data existed when the block was published to get into its hash. As each block contains information about the block before it, they form a chain, with each additional block reinforcing the ones before it. Therefore, blockchains are resistant to alteration of their data because once recorded, the data in any given block cannot be altered retroactively without altering all subsequent blocks.

Public, Private, Federalized and Hybrid blockchains inherently have disadvantages especially as they relate to new and existing physical, intangible, tangible and digital creations. For instance, while Public blockchains are the Peer-to-Peer (P2P) consensus method of choice, they however suffer from a lack of transaction speed and cannot scale. The greater the nodes, the slower and clumsier the network becomes. New enterprises require both confidentiality and reliability based on scaling access as the company grows.

Private blockchains are not truly decentralized. This is one of the biggest disadvantages of private blockchains and goes against the core philosophy of achieving trust through distributed ledger technology or blockchains in general. Private blockchains use a smaller number of nodes in comparison to public blockchains which exposes them to increased security risks and fraud.

Federated blockchains are only partially secure and limited for two primary functions: to validate transactions and initiate and receive transactions. Federated blockchains can be compromised due to the member's integrity and lacks transparency. Although Federated blockchains are needed for transactions, they wholistically cannot meet the needs of a new enterprise.

Hybrid blockchains are unlike Federated blockchains and attempt to deploy both aspects of private and public blockchains. However, Hybrid blockchains are not completely transparent, difficult to upgrade and offer no incentive for participation and contributions to the network.

Non-Fungible Tokens (NFT)s are defined as a unique and non-interchangeable unit of data stored on a blockchain, a form of digital ledger. At present, NFTs are used to market some “Digital Rarities” through tokens but create distinct limitations as it relates to many tangible and intangible assets and are limited by crypto tokens which are highly volatile, speculative and unvetted. The present state of the cryptocurrencies marketplace and cryptocurrency exchanges such as the widely-publicized “FTX,” for example, is the result of lack of fiduciary oversight and absence of certifiable and verifiable token valuation resulting in millions of investors losing their life savings.

In addition, a fundamental problem is created with the deficiency of asset due diligence arises when listing on NFT marketplaces such as the Opensea, for example, when a person creates an electronic image of an unvetted art asset, attaches a token to it with an artificial value, and puts it up for sale on a virtual marketplace. Here, there is no link to the original work and thus, the minted token is often a breeding ground for fraudulent reproduction.

People in favor of decentralized platforms, desire social change through blockchain technology and perceive aggregation platforms owned by megacorporations such as Google, Apple, Amazon and Facebook, and other organizations unfairly stifle free enterprise and harm small and medium size businesses as well as individual creations through centralized control through their bundled services and protocols. Decentralized advocates want individuals to completely own their data. Others in favor of centralized structures view decentralized operations as guideless, entangled, directionless, managerially inefficient, unregulated, and ripe for fraudulent activity.

The above background takeaways are: 1. centralized and decentralized systems lack appraisal standards and vetting for listed NFT assets 2. Crypto exchanges lack oversight and compliance and 3. present blockchain architectures are deficient when applied for new organizational enterprises.

Thus, there is a need for a technical solution and new architectural blockchain model, platform(s), standards, and protocols designed to provide managerial tools to help actualize and commercialize new and existing intellectual property verticals through collaborative product and service development.

In addition, although Bitcoin and Ethereum stimulated the prosperity of the decentralized application (dApp) market, these were not designed to protect investors, to enhance and enterprise's product & service development, to certify asset authenticity. These were also not equipped to directly and tangentially provide token oversight nor provide and maximize transactional value (ROI) with the emergence of Web 3.0, 4.0, and 5G, 6G, etc.

Furthermore, there is a profound need to utilize new systems and methods to reduce startup failure rates whereby 9 out of 10 startups fail (90%) (source: Startup Genome—the 2019 report claims 11 out of 12 fail).

At present, NFT technologies are not designed for new creative IP vertical collaboration nor collaborative and concentric royalty protocols for new makers and collaborative Intellectual Property innovations. The present disclosure will describe new technological architectural systems, blockchain models and exchange trading technologies, datasets, devices and tools which will methodically provide new technological help, aid and assistance hereinafter referred to as GOAT (Genisor Operational Auxilium Toolkit) for startup organizations for new innovations and to enhance product success through new methods, systems and technology as described as follows:

### SUMMARY OF INVENTION

The following present disclosure describes methods and systems and elements and processes to reduce the risks associated with startups through customizable Auxilium tools. According to the Merriam-Webster Dictionary, “Auxilium” is the Latin word for help, aid or assist. The primary Glossary of Terms and Definitions include:

Genisor Operational Auxilium Toolkit (GOAT) which is for the purposes as defined as all operational software, firmware, hardware, network(s), protocols, methods, systems, and protocols that help, aid and assist new product and service development and asset creation for any purpose, in any field and discipline, and in any stage of development including but not limited to idea creation through product introduction and beyond.

The present disclosure specifies new technologies, systems, tools, methods, apparatuses, and processes to streamline operations and product development, lower risk as well as to increase the value proposition for newly created and previously created assets through a new blockchain performance model and new applications, protocols, standards for oversight and compliance (SEC).

GOAT software tools are also designed for asset verification, investment fiduciaries, investment advisories, broker-dealers, investment bank services and transaction exchange integrity as therein described.

The present disclosure provides a description of systems and methods for Auxilium based milestones for Genisor Platform Non-Fungible Assets (NFA) and Non-Fungible Tokens (NFTs). In one embodiment, GOAT technology is defined as asset-backed securitized tokens and blockchain technologies to help assure authenticity, transparency, valuation, governance, fair marketplaces and exchanges as well as Security Exchange Commission registration and regulatory enforcement from or their equivalent from other international countries and government oversight authorities for all securitized trading self-regulatory investment assets.

### Glossary of Primary Words and Definitions

“Genisor Operational Auxilium Toolkit (GOAT)” is defined as one or more Specialist and experts, Artificial Intelligence (AI) and M2M in any industry, North American Industry Classification System (NAICS) code classifications in any field that aid, help, train, and assist asset product and development including but not limited to asset appraisal, valuation, authenticity and certification, command logic, methods, AI, M2M, resource fulfilment, decision-making software, methodologies, technologies, logic, platforms, communication networks, business management services software, document creation, guidance and tutorials, networks, APIs, operational software, equipment and apparatuses to increase asset value, productivity, efficiencies, collaboration, etc., to expedite product and service creations throughout the product and service lifecycle. The term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms etc. Additionally, a “processor” can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

Furthermore, GOAT can customize settings to streamline timestamped developmental milestones and user access to resources such as: capital, legal services, and accounting services, among others, in order to maximize revenue generation and profits. GOAT is, in various embodiments, capable of permitting users to customize the hardware and specific tasks required by various organizational goals. Alternately, GOAT can employ its network of specialized knowledge and AI base to offer specific hardware and software recommendations as well as tasks pertinent to a particular organizational goal. As warranted, field settings can be customized to integrate with various external interfaces and software applications for the purpose of licensing to third parties.

GOAT software securely records, vets and certifies assets listed on the Rarity Trading Platform (RTP) through a variety of analytical models of renumeration and transcribed via milestone blockchains.

Furthermore, in other embodiments, GOAT utilizes a combination of Machine-t-Machine (M2M), Artificial Intelligence (AI) and manual resources to match potential investment capital held in the Rarity Trading Platform (RTP) with numerous projects. GOAT enables investors in the RTP the ability to efficiently analyze and evaluate an organization's potential and future value.

GOAT Software Tools and Resources provide dynamic guidelines, governance and oversite for the project NewEnt. to expedite product and service development (MVP and CVP) advanced business tools including M2M (AI) through all stages of the product and service lifecycle from concept, Minimum Viable Product (MVPs) through product completion and commercialization (Commercial-Viable-Product) through brand awareness, growth and product expansion, diversification and exit strategies.

“Rarity Trading Platform (RTP): is generally defined as a platform designed for over-all support and secure trading architecture that utilizes the Genisor Operational Auxilium (GOAT) software for creators and product and service developers. RTP process servers securely store data and information of a new and existing intellectual property asset, series of assets, and pool of assets (tangible, intangible, physical and digital) designed for primary and secondary trading. [00027] Furthermore, RTP can trade both physical and Virtual digital twin assets and non-fungible assets of one or more types of securities and financial vehicles i.e., ETFs, mutual funds, bonds, derivatives, cryptocurrencies, debt vehicles, etc. In addition, the RTP can include one or more broker-dealers and financial advisors in conjunction with a plurality of verified milestone product development deliverable gateways utilizing GOAT software and hardware tools for the Enterprise Organization's nascent development.

GOAT software is designed to lower startup risk for collaborating creators through series of interlocking deliverable milestone plateaus including full service architectural services that synchronizes and vet milestone input data, provide analytics, and indexes for investment banks and other users, including but not limited to exchanges, Stock, Crypto, Central Bank Digital Currencies (CBDC), Metaverse and Omniverse exchanges as previously stated.

The combined services of the RTP platform and GOAT Software Applications are defined to include but are not limited to one or more: intangibles, tangibles, collectibles, marketplaces, indexes, exchanges (web, iOS, Android applications, and exchange services, etc.), platform(s), fee structures, ownership, title registrations, ownership tracking, governance, creators, social media, identification, timestamps, assets, fractionalization(s), virtual geographies, transfer of title, valuation(s), P2P networks, blockchains, wallets, mobile wallets, credit and debit cards to add funds, mining and minting, two-dimensional (2D), three-dimensional (3D) graphics, holograms, passwords verification, programmers, tokens, cryptocurrencies, data creation tools, amplification, collection, clearing houses, recording, analysis, processing, transmission, delivery, storage, encryption and security sectors, contracts, exchangeable(s) and non-exchangeable(s).

“Genisor NewEnt” is defined as new and existing enterprises and for profit and nonprofit organizations, domestic governments (local, state, federal) and international government organizations.

“Milestone Blockchains” are defined as a component of the RTP system and the GOAT software platform that enables entrepreneurs as well as established companies and organizations with step-by-step Milestone Guidelines throughout the product development (P&D) lifecycle though coding and encoding when certain P&D milestones are achieved. Milestone-based blockchain applications map and chronicle an organization's achievements and progress. In addition, Milestone-based Blockchains integrate deliverables as it relates to an organization's analytical evaluations and if “positive”, meaning, able to achieve the milestones and deliverables as vetted by the Milestone-based Blockchains, reward the organization (NewEnt.) with access to capitalization funding and other advantages.

Milestone-based Blockchains work by utilizing cryptography and directly integrate milestone gate stages and corresponding deliverable datasets with blockchain entries and cryptographic hashes of the initial milestone gate block data sets and subsequent timestamp blocks of an organization's data, trading and managerial process. The milestone-based blocks have certain storage capacities and, when filled, are closed and linked to the previously filled milestone data block, forming a milestone-derived data chain known as the blockchain. Allowing an organization's information, a degree of managerial transparency when required through the vetting of newly-added block data before its compiled into a new format block, which will then be added to the chain once it is filled in.

In addition, the RTP platform and GOAT software applications include all asset classifications, all high-value rarity classifications, rarity subclassifications, all asset subclassifications, all digital asset classifications, virtual reality, augmented reality, algorithms, encryption and decryption codes, computer codes, ecosystems, domain names, patents, copyright, agencies, advisors, creator's (s') IP, collaborators, financial vehicles, verticals, investors, consumers, users, metadata, datamining, data harvesting, protocols, datasets, descriptions, open and closed sources, forensic analysis, interpretations, ledgers, distribution purchase options, decentralized Interplanetary File System (IPFS), financials, investment fundamentals, technical analysis, news sources, media, advertising and promotion, databases, systems, subsystems, managers, collaborators, private keys, public keys, private and public protocols, tutorials, formats, languages, laws, rules, applications, bids, asks, market makers, submissions, and pricing structures, cognitive computing, and e-commerce subscription models, customers service(s), all business service software models, mobile services, mesh networks, satellite networks, cellular networks, Wi-Fi, MiFi, fraud detection, notification, alerting, notification, Application Programming Interface or API (cloud), IT services, communication networks, hardware and software (apps) devices, software and services, systems software, software research and artificial intelligence software sectors, avatar(s), frequencies, audio, visual, holograms, written, scripted, outlined, storybooks, space, time, emotion, senses, podcasts, authorship for all IP where fractionally traded or wholistically traded.

In addition, the RTP platform and GOAT can include, microverses, metaverses, omniverses, Defi, Dapps, milestones, deliverable, pricing models, compensation models, liquidity models, reimbursement and remuneration models, royalties, profit sharing, revenue sharing, fiat currencies, tokens, crypto currencies, and all relevant and pertinent programming codes for functionality of the system(s), platform(s), M2M (artificial intelligence, robo-trading), AI assisted tools, customization modes, setting and ancillary modes and transactions, gas fees, proformas, PPMs, executive plans, and other planning, 4P's logistics, human resources, social networks, marketing networks, promotional networks, fractional ownership, single asset, transactions, pooled assets transactions, metaverse transactions, omniverse transactions, licensing, managed funds, unmanaged funds, compensation and all combinations of the above.

### BRIEF DESCRIPTION OF FIGURES

The scope of the present disclosure is best understood from the following detailed description of exemplary embodiments when read in conjunction with the accompanying drawings. Included in the drawings are the following figures:

FIG. 1. Is a block diagram representation illustrating a high-level system architecture of the Genisor Operational Auxilium Toolkit (GOAT) for processing, storing and tracking the progression of product development deliverables and data through Milestone Blockchain storage in accordance with exemplary embodiments.

FIG. 2. Is a schematic diagram of the Genisor Management Team product, Milestone Based product and service progression and data transitional map via Blockchain in accordance with exemplary embodiments.

FIG. 3. Is a flow diagram illustrating the Rarity Trading Platform (RTP) and ecosystem as it relates to various physical, digital, intangible and tangible IP classifications and subclassifications relative to transactional data and analytics in accordance with exemplary embodiments.

FIG. 4. Is a block diagram illustrating the GOAT process, communication, functions including frontend and backend services rendered to RTP users in accordance with exemplary embodiments.

FIG. 5. Is a block diagram and flow schematic of the Genisor Controller Management Team System and a plurality of software auxiliary/AUX settings that access various utility product development services on the RTP ecosphere in accordance with exemplary embodiments.

FIG. 6. Is a block diagram illustrating required information for RTF onboarding, policy terms, and deliverable milestone requirements and valuation assessment in accordance with exemplary embodiments.

FIG. 7. Is a block diagram illustrating scalable and adaptable decision-making software for Genisor Control Managers and team members in accordance with exemplary embodiments.

FIG. 8. Is a high-level graphic illustration of secure primary and secondary trading of created physical and tangible assets on the RTP exchange as well as supporting software for fundamental and technical analysis for both real and virtual marketplaces in accordance with exemplary embodiments.

FIG. 9. Is a high-level graphic illustration of secure primary and secondary trading of created digital and intangible assets on the RTP exchange as well as supporting software for fundamental and technical analysis for both real and virtual marketplaces and exchanges in accordance with exemplary embodiments.

FIG. 10. Is a chart illustrating RTP investor data transactions and customer accounts and financial data fees through original and destination identifiers and transparent storage via blockchain in accordance with exemplary embodiments.

FIG. 11. Is a block diagram of rarity backed SEC securities as represented by a plurality of managed and unmanaged financial vehicles for one or more non-fungible assets in accordance with exemplary embodiments.

FIG. 12. Is a graphic illustration of a mobile tracking sensors and global location trackers retrieved by the RTP processor and securely accessed by Auxilium Specialists, Investors and Genisor Managers in accordance with exemplary embodiments.

FIG. 13. Is a flow diagram illustrating a mathematical conversion ratio as an exemplary method to convert physical images to digital and virtual asset twins with the integration of enriched data in accordance with exemplary embodiments.

FIG. 14. Is a flow diagram of a New Enterprise (NewEnt.) Organization collaborating to create new IP music assets and IP on the RTP ecosystem with a variety of remuneration models based on production and published milestones in accordance with exemplary embodiments.

FIG. 15. Is a flow diagram of Genisor NewEnt. organizational documents and information required by RTP members and fiduciary advisors for governance before listing in accordance with exemplary embodiments.

FIG. 16. Is a flow diagram of Genisor NewEnt.'s organizational documents and data such as agreements, financial information and personnel information stored via blockchain in accordance with exemplary embodiments.

FIG. 17. Is a detailed flow diagram timeline of Genisor NewEnt.'s financial data requirements and fulfillment queries to meet initial RTP Milestone requirement and standards prior to capitalization in accordance with exemplary embodiments.

FIG. 18. Is a flow diagram of Genisor NewEnt.'s organizational documents and data such as intellectual property ownership, Environmental hurdles and infringement detection Vettenization software and legal enforcement in accordance with exemplary embodiments.

FIG. 19. Is a table and diagram of the RTP application layer including various hardware and software requirements and standards needed for the product development process layer and product development in accordance with exemplary embodiments.

FIG. 20. Is a diagram of a general milestone capitalization process based on objectives and tasks Milestone Gate Progression levels NewEnt. must achieve prior to corresponding tiered funding in accordance with exemplary embodiments.

FIG. 21. Is a graph that exemplifies Non-Fungible-Assets' (NFA/NFT Marketplace Exchange) financial data on various mobile apps and devices with interchangeable Metaverse and Omniverse trading modes in accordance with exemplary embodiments.

FIG. 22. Is a diagram that demonstrates the Genisor Platform Milestone-Based Concentric Product Progression from concept through Product Introduction and Resulting Valuation in accordance with exemplary embodiments.

FIG. 23. Is a diagram that demonstrates how asset trading through RTP interfaces with the Metaverses and Omniverses.

### DETAILED DESCRIPTION OF FIGURES

The following detailed description illustrates the claimed disclosure by way of example and not by way of limitation. This description will enable one skilled in the art to make and use the claimed disclosure, and describes several embodiments, adaptations, variation, alternatives, and uses of the claimed disclosure.

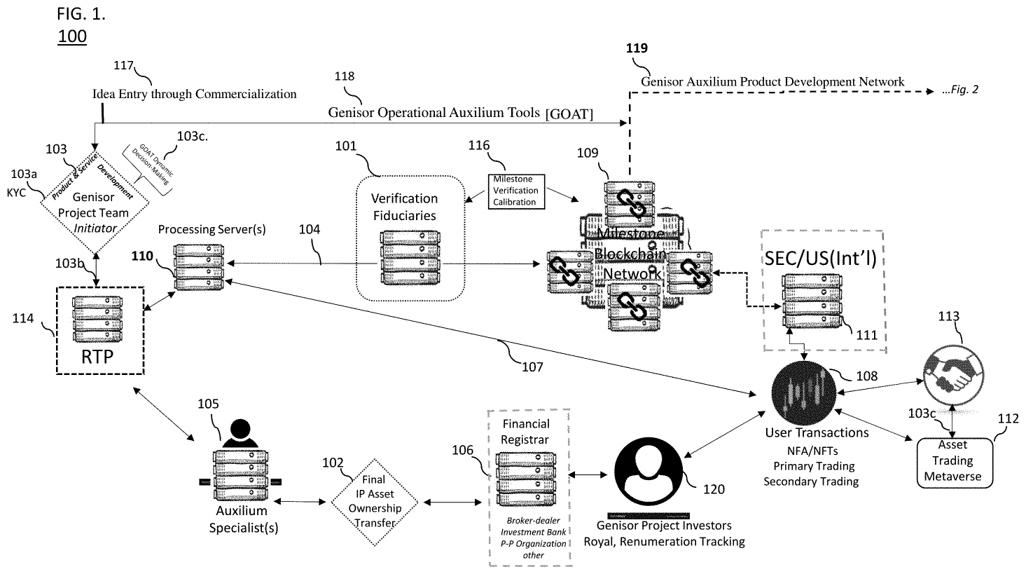

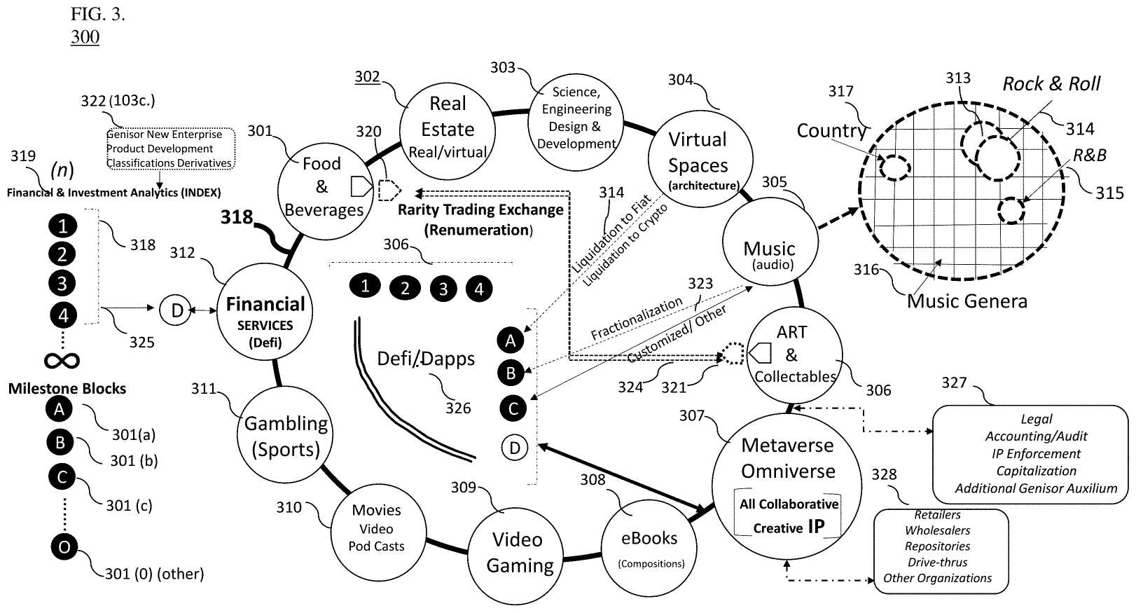

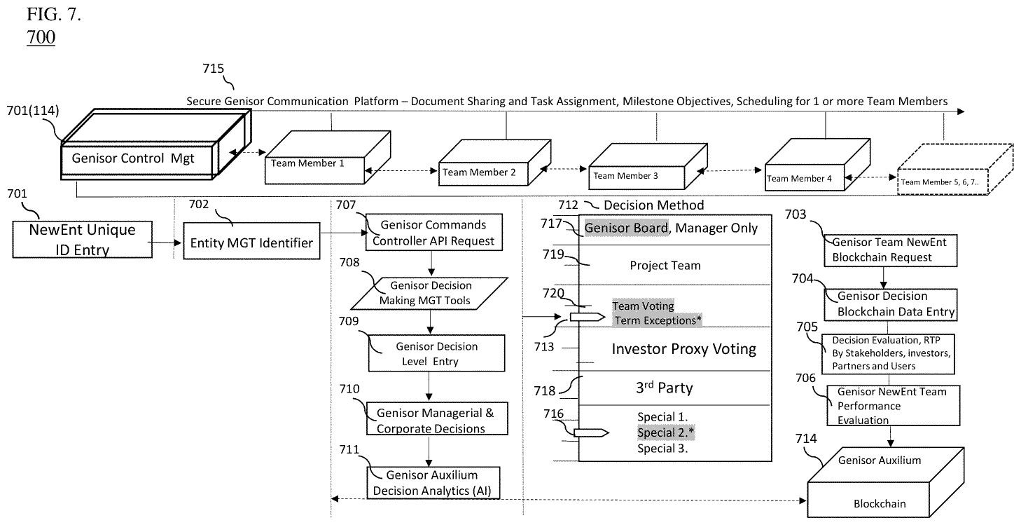

FIG. 1. 100 is a block diagram representation illustrating a high-level system architecture of the Genisor Auxilium Operational Toolkit (GOAT) 118 comprising software to process, store and track the progression of product development deliverables and data through Milestone Blockchain in accordance with exemplary embodiments. NewEnt. GENISOR MGT 103 and as previously defined in the Summary of Invention's glossary is the lead (control) manager(s)/owner(s) of one or more rarity creations as described by FIG. 3. GOAT can dynamically program various decision-making applications and tasks as it pertains to creative collaboration and business evaluations as represented by 103c and the Rarity Trading Platform RTP 114 described in detail in FIG. 7. GOAT software is designed to manage one or more projects from the idea stage through completion and beyond for Genisor NewEnt. Managers 103. Goat Operational Auxilium Tools (GOAT)118 comprises managerial guidelines, models, logic and applications throughout the product and service lifecycle.

RTP 114 provides an Auxilium (resource support) platform exemplified in the “Real Verse” (physical, object, facility, etc., representation) Metaverse, Microverse and Omniverse. 109 represents a blockchain ledger and network component designed for the Genisor project team to ascertain an organization's fundamental product and service development milestone deliverables as immutably logged by the Milestone Blockchain 109 and transcribed Genisor NewEnt.s' deliverables based on (t) time versus 1. required data entry requirement information and 2. (t) time versus NewEnt.'s Manager/Owner milestone forecasting and discrepancies (variances) thereof.

The 114 RTP's 118 GOAT Auxilium Software enables Genisor Product and Service tools to streamline and help optimize the monetization of their innovations and ideas. In other words, the 114 RTP system utilizes advanced tools, M2M and human resources from the startup stage post Genisor NewEnt. RTP 114 registration through the product lifecycle (Introduction, Growth, Maturity, Diversification, Decline) such as product concept, requirement gathering, design and development, technical support, brand name development, 4p's, website, prototyping, testing and validation, use cases, pre-certification (if required), Minimum Viable Product, alpha, beta, delta prototype design through commercialization and market introduction. It is obvious to anyone familiar with the art that the steps, tasks, objectives and goals relative to specific deliverables vary in accordance with the classification and sub-classification of products and services described in FIG. 3.

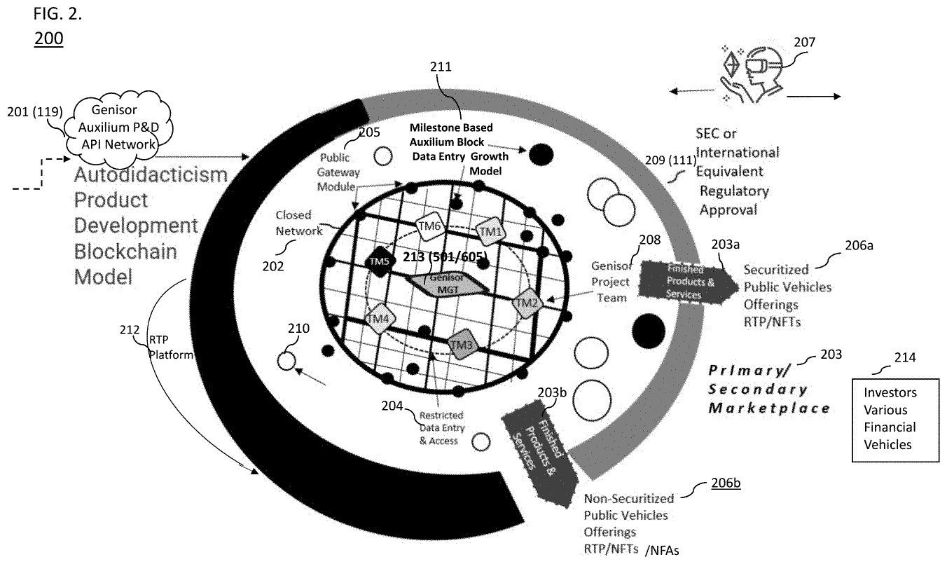

Milestone Blockchains as described and referenced in FIG. 2. can include entries from emerging New Enterprises (NewEnt.) or Existing Enterprises and organizations enrolling and accepted in the 114 RTP platform and for the sake of brevity, the present application refers to both new and existing enterprises as NewEnt. Genisor Milestone Blockchains 109 includes records blocks that are linked together using cryptography. Each block contains a cryptographic hash of the previous block, a timestamp, and transaction data. The blocks have certain storage capacities and, when filled, are closed and linked to the previously filled block, forming a data chain known as the blockchain. All new information that follows that newly added block is compiled into a new format block, which will then be added to the chain once it is filled in.

In one or more embodiments the functions described and may be implemented in hardware, software, firmware, or any combination thereof. If implemented in software, the functions may be stored on or transmitted over as one or more instructions or codes on a computer-readable medium and executed by a hardware-based processing unit 110. The computer-readable medium may include: a computer-readable storage medium corresponding to a tangible medium such as a data storage medium; or communication media including any medium that facilitates the transfer of a computer program from one place to another, such as according to a communication protocol as exemplified by 117. In this manner, the computer-readable medium may generally correspond to a non-transitory tangible computer-readable storage medium, or to a communication medium, such as a signal or carrier wave. A data storage medium may be any available medium that can be accessed by one or more computers or one or more processors to retrieve instructions, code and/or data structures for implementation of the techniques described in this disclosure. The computer program product and component may include a computer-readable medium.

Secure Information and data transmission (Genisor Auxilium Product Development) 119 can be loaded into and/or executed by a machine or transmitted over one or more secure transmission mediums or cellular carriers, electrical wiring and cabling, satellite, Mesh networks, fiber optics, and via electromagnetic radiation, microwave, etc., wherein the program code is loaded into and executed by a machine, such as a computer, an apparatus, network, API or a combination of one or more applications used when practicing the invention.

114 references the RTP system processer 110 and the receival of transmission of data from the RTP Auxilium staff referred to as RTP (GOAT) Specialists 105 and Genisor Members 103. Auxilium Specialist 105 consists of a 114 RTP system where the Genisor Manager and one or more Genisor Project Team Members 103 receive data, information, images, video, audio, holographs, instructions, tutorials, forms, and a plurality of business analytics from the 114 RTP Platform system's memory, and a system bus that couples system components including, but not limited to, the system memory to the processing unit 110.

The Genisor Product Development Network consists of one or more network interfaces and incorporates wire and/or wireless communication networks such as but not limited to wide-area networks (WAN), local-area networks (LAN), regional-area, (RAN), geographical-area (GAN) and International-area (IAN), cellular networks, Integrated Services Digital Networks (ISDN). Distributable Data Interface (FDDI) satellite networks, fiber optics and copper optic networks (FDDI, CDDI). DSL. Packet Switching Networks (PSN) Ethernet, Secure Trading Exchange Networks (STEN) and the like. WAN technologies include, but are not limited to, point-to-point links, circuit switching networks like Integrated Services Digital Networks (ISDN) and variations thereon, including packet switching networks and all network coupling and combination network connection, transmission and receiving apparatus required and provided by the RTP 114.

In addition, the Genisor Project Team Manager 103 can orchestrate and control the data dissemination and communication hierarchies through GOAT 118 from one or more Genisor team members through various levels of restrictive program codes in order to bifurcate tasks, documents and information if required. Furthermore. GOAT 118 software programs settings can automatically transmit NDA documents prior to 3^{rd} party access. GOAT 118 software can be set to limited portions of document access that does not contribute to the optimal product development continuum as deem by one or more NewEnt. Managers.

The RTP 114 process server 110 can store data on one or more servers, one or more systems and subsystems and can receive secure data from one or more member's computer and can generate and transmit and receive new documents via processor 110. The processing unit can include dual processors, a single processor and any combination of 114 RTP's processors 110, (microprocessors and other multiprocessor architectures), multiple locations and representative of actual “real” physical facilities for instance as well as one or more virtual and avatar representations. 112 digital twins that either mirrors the “real” and actual physical situation, object, entity, organization, person, etc.

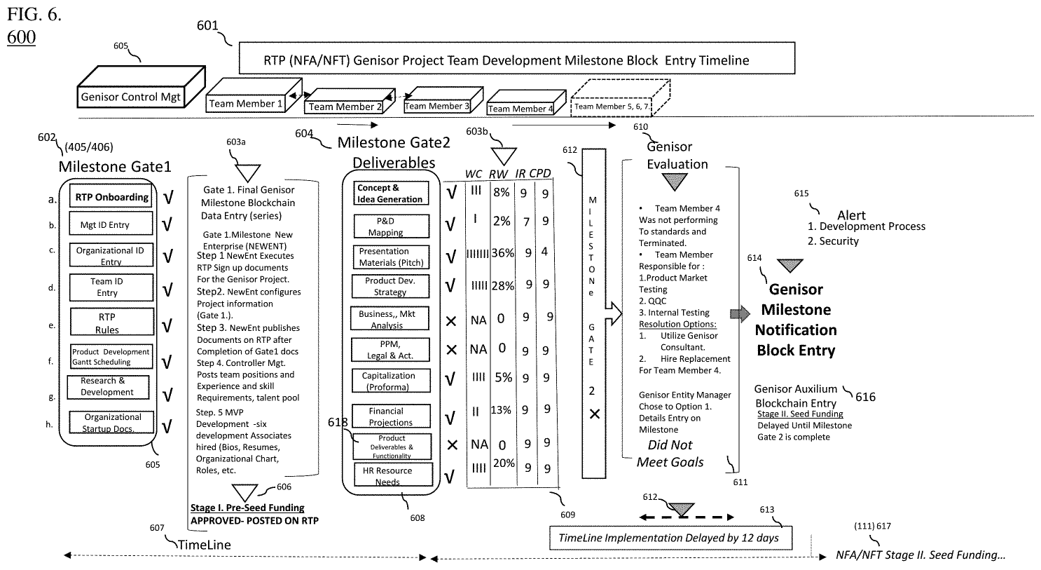

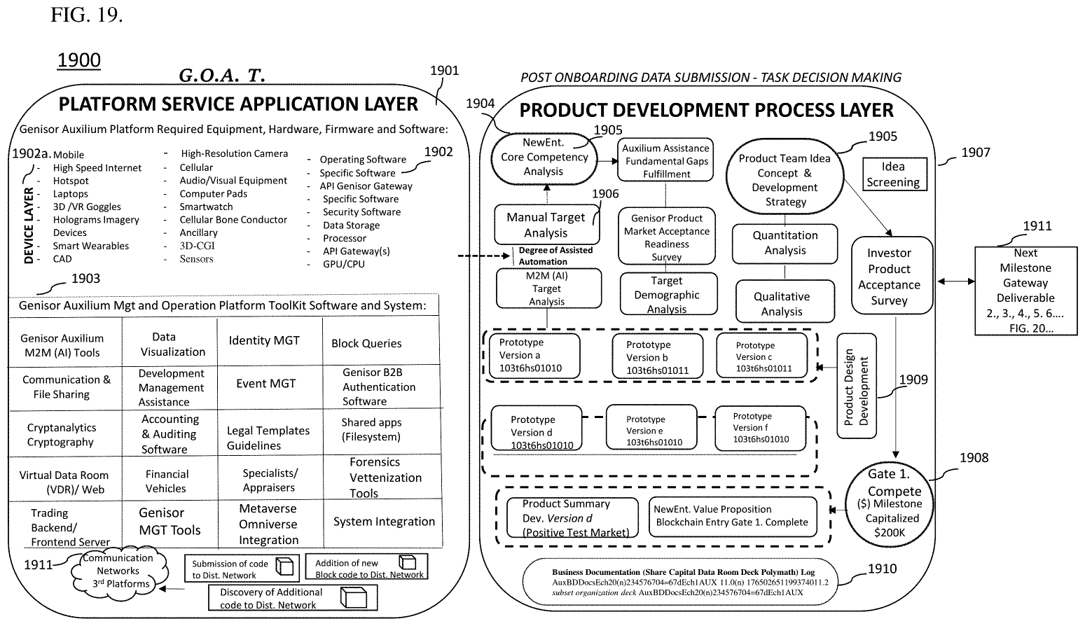

The RTP System 110 and Milestone Blockchain Gates described in FIG. 6, can synchronously and asynchronously access data from one or more Genisor New Enterprises (NewEnt.) Manager(s), Owner(s), Proprietor(s), Controller(s), Leader(s) that require a form of computer control timing protocols triggered by a request for a specific operation and can begin the operation upon receipt of an indication (signal) that precedes or in parallel to the operation task and assists in tracking progression of the task until the task is completed or in some incidences not completed. In addition, the computer processor 110 device can include one or more: memory storage components, microphones, high-definition cameras, software operating systems, communicators, 118 (GOAT) operating controller software, business management tools applications and can operate in a networked environment using servers, workstation logistics, secure connections to one or more remote computers such as but not limited to personal computer(s), networks, PCs, router(s), microprocessor-based appliance(s), peer-to-peer devices or other network nodes, etc. which is further described and detailed by FIG. 19.

In addition, the RTP system 114 can include many or all of the elements described relative to one or more protocols, computer(s), ecosystems, networks and trading exchanges, and as represented by 109, Milestone Blockchains, etc. as further described by FIG. 2. Although blockchain records are not unalterable, forks are possible, and thus, blockchains may be considered secure by design and exemplify a distributed computing system with high antifraud and default tolerances but not totally immutable.

103 NewEnt.'s IP can be transmitted by 104 representing the communication link (wirelessly or wireland, etc.) that links the RTP 114 processor 110 to the platform's Milestone-Blockchain in order to log all pertinent data and information relative to 103 Genisor NewEnt.'s creations including, physical, digital, tangible and intangible creations of various assets entered that are screened, vetted and verified by one or more fiduciaries represented by 101. The Process server 110 and the RTP's systems AI can dynamically program needed verifiable data through various parties, channels and advisors through the RTP ecosphere.

110 exemplifies the Rarity Creators' Ecosystem which enables creators to collaborate with other creators in a plurality of disciplines including the sharing of ideas, expertise, cross licensing IP, shared research, shared knowledge and shared resources i.e., overhead, fixed cost, legal and accounting fees, expertise, experience, social network access, software, hardware, firmware, and a host of other functional operations, etc.

The RTP process server 110 links, transmits and receives as represented by 107 including financial transactional data represented by 108 NFA/NFT User (customers, investors transactions). In addition, the User 108 trading ecosphere can include other 3^{rd} party exchanges outside the RTP ecosphere by the terms of use and licensing agreement.

The selling, trading and fractionalization of ownership of new asset creations in the primary (IPO, ICO, ITO, etc.) and secondary marketplace is exemplified by 108. 104 denotes the Rarity Trading Platform's 114 communication link in the process of entering data through the 109 the Milestone Blockchain. The RTP 114 platform's processor 110 can utilize one or more platform API support sites to assist creators through various points of time in the GOAT process including but not limited to 101 Verification Fiduciaries.

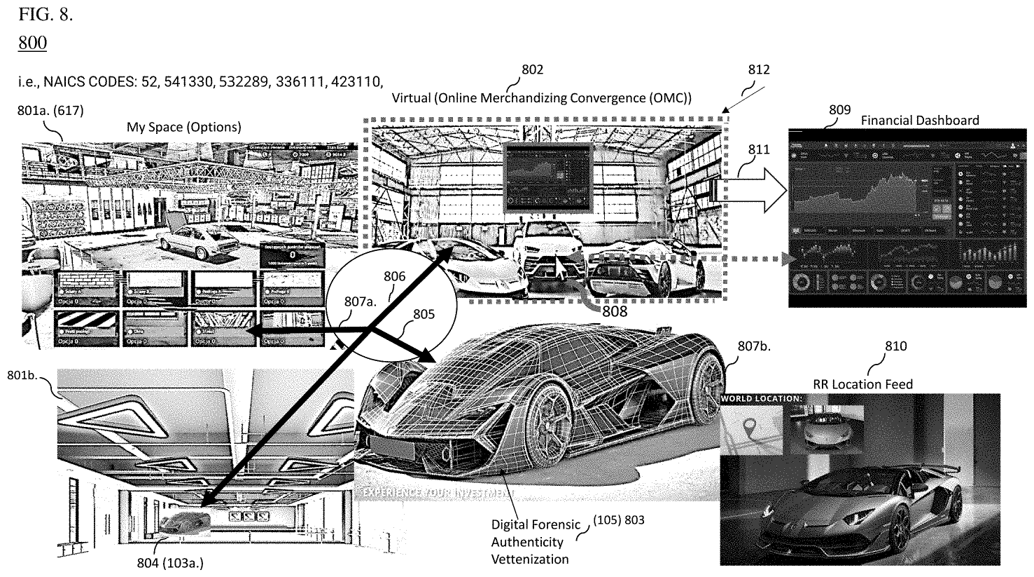

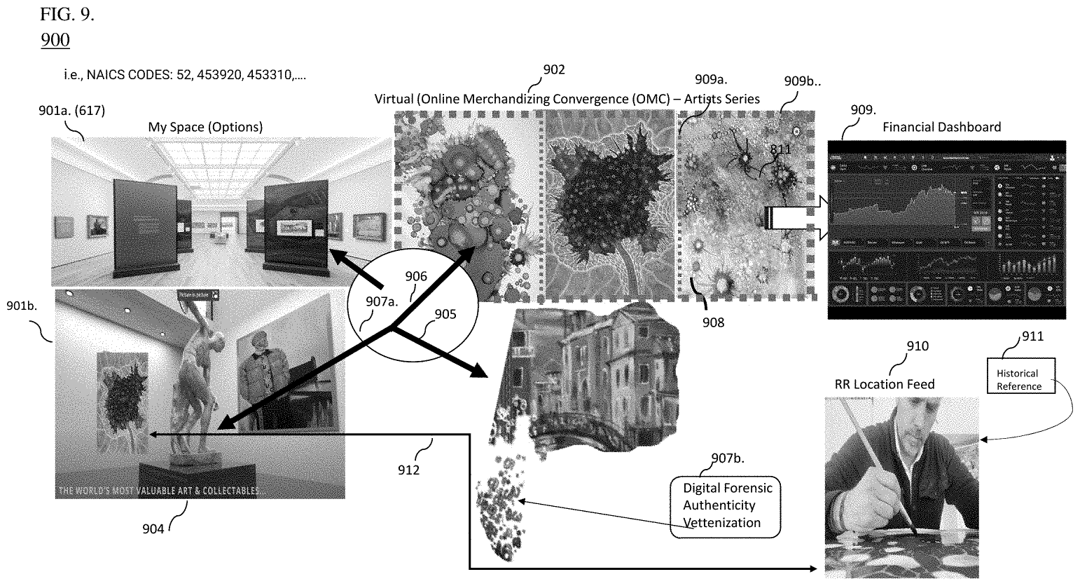

Further Embodiments encompass the creation and collaboration traded on traditional exchanges 108 (NFA/NFT) and its digital twin represented by 112 as previously denoted can trade the same or similar assets in different forms. 112 assets can be enriched and comprise animated VR and AR enhancements, and other enriched data including but not limited to forensic data and other Vettenization data as well as (illustrated by FIGS. 8, and 9). 103a) references the broad term “Know Your Customer” (KYC) whether assets are exchanged and traded in a Traditional Mode (format) or a Virtual Mode (format) and/or a combination of both.

More specifically, Genisor idea creators must provide RTP 110 Specialist (staff and associates) reliable data including concept detail regarding market opportunities and proposed solutions.

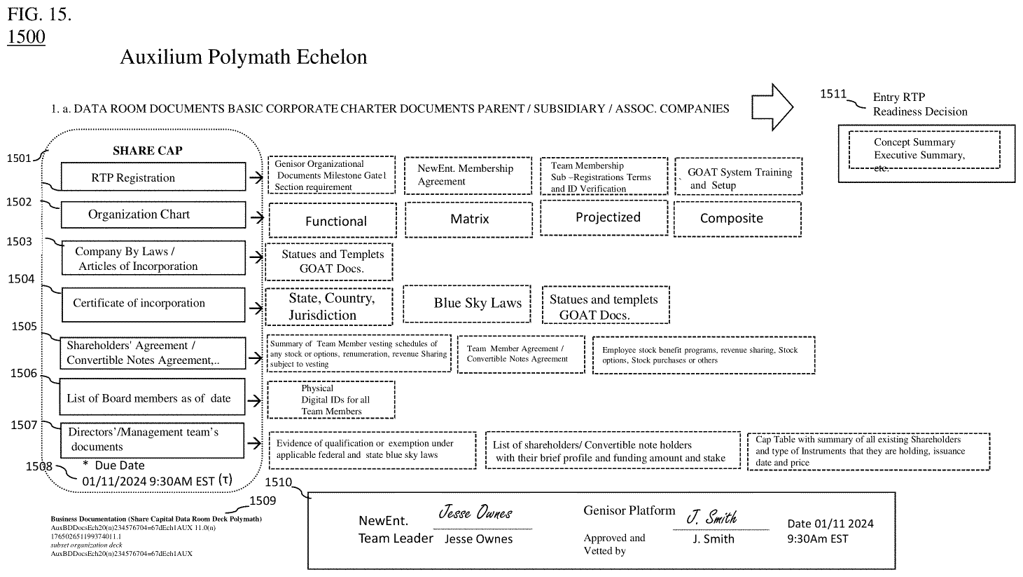

NewEnt. in another embodiment can answer one or more series of questions proposed by the Specialists in support of their solutions. GOAT software analytics can assist and provide feedback and suggestions through various evaluation software mechanisms. NewEnt. 103 Genisor-provided documents can include financial forecasts, executive summaries and basic foundational information as described and exemplified by FIGS. 15, 16, 17, 18 and in part FIG. 6.

In another embodiment, the Metaverse Mode can include both (112) ownership title transfer (102), one or more networks, servers, platforms, ecospheres, etc. are programmed, logged, entered on the milestone blockchain ledgers (109) in order to track the creators, creations, trademarks, copyrights, brands as well as subsequent.

101 also includes Verification Fiduciaries for both inhouse and governance verification but is not limited to ownership, title, authenticity, and all other variables required for transparency and ownership rights, tenure, contract(s), status and all other representations and data.

116 represents 3^{rd} party milestone enriched verification and calibration technologies that can accompany the asset in order to help seamlessly integrate the asset with one or more exchanges, software protocols, directions, avatars, virtual reality, physical to digital conversion technologies relative to milestone progression calibrations, financial and investment calibrations, vettenization data and other imbedded information added to the hash milestone blockchain 109 for one or more assets.

112 again signifies the final Metaverse twin rarity 108 NFA/NFT offering resulting from Genisor NewEnt. 103, in conjunction with 118 GOAT a Multi-Auxilium assistant and tools access represented by 103a for entrepreneurs developing an idea and initial conception of the idea through product and service development of Minimum Viable Products (MVPi), Minimum Viable Prototypes (MVPii), Minimum Viable Valuation (MVV), commercial development signified by 117 of the product and service and marketing the product and service after membership registration on the RTP 114.

Furthermore, GOAT 118 includes but is not limited to an assortment of multivariant, multidiscipline, multi-software apps, multipurpose hardware, business method software, scoping templates, strategic methodologies, financial tools for both fundamental and technical analysis (online trading dashboards) software integration, valuation technologies, legal document formation assistance, accounting software, marketing software and 4P's tools and mentoring referred to by 105 as Auxilium Specialists (as defined in the Summary of Invention Glossary) through experts in a plurality of fields and disciplines for all phases of Product and Service development offerings which, as shown in 112, can be presented in many forms (financial vehicles, verticals, etc.) as well as include all classifications of rarities and sub classification of rarities.

102 represents product and service ownership title transfer whether it is a finished product and service purchased by the customer, an investor's fractional share ownership, and/or a Genisor NewEnt.

103 technology licensees as well as RTP sub-licensees, etc. 103b references one or more secure communication links between the RTP platform and Genisor NewEnt. 103. In addition, 111 represents all or most investments in the RTP exchange and in various Genisor organizations, SEC registration and approval to trade on one or more financial “stock” and “crypto” etc. exchanges through licensed broker/dealers 106 and international equivalents. In addition, Genisor NewEnt. commercialized products and services remuneration referenced by 120 includes royalties, revenue (profit) and revenue (profit) sharing, dividends warrants, options, sweat equity, time based equity, and other forms of renumeration. 113 signifies the social network relative to global asset demand and supply of newly created assets, past created assets and high-value assets referred to as rarities.

Genisor Project manage node(s) and the Creative Collaborator nodes include the Collaborator subsidiary node includes data information of the collaborator as well as hash royalty renumeration value(s), and data associated with an intangible or tangible sub-asset of the newly created asset offering(s). The RTP program can also include generating one or more secondary and tertiary marketplaces, and trading dynamics, etc. Nodes can address a response to an assembly of one or more or a series of newly created intangible and tangible asset or sub-asset classifications. In other words, intangible and tangible sub-asset and/or in response to a modification to a new rarity asset can include a new tertiary offering traded on the RTP.

As described herein, some embodiments of the present invention might be implemented as a software application downloadable to a mobile device. The downloaded software application might work with existing hardware of the mobile device to implement an emergency notification alert system as described herein. For example, some embodiments might be available as an “app” or icon on the screen of the mobile device. Alternatively, some embodiments of the present invention might require special purpose hardware, and this might only be compatible with mobile devices programmed with RTP trading alerts and notification.

Furthermore, these new creations may require redirection, tweaking, multivariate process variations and new strategic direction when dealing with environmental changes such as inflation, competition, and supply chain logistics to name a few examples. The present disclosure references one primary glossary term as Nonfungible Assets (NFA) which include but are not limited to various Ecosystems and parallel trading methods for one or more Virtual Metaverse environments such as (Virtual Reality (VR), Augmented Reality (AR) which are familiar terminologies for anyone familiar with the art. However, the present disclosure will describe needed terminology relative to Transactionally Immersive Metaverse Environments (TIME) some of which include Actual Virtual Exchange (AVE) which may include immersed actual locations of physical rarities referred to be referenced as “Real Rarity Environments” (RRE) where by definition, the physical asset is securely located, i.e., in museums, galleries, and other securely stored facilities. Trading and the ownership exchange may also be in parallel. Parallel trading offering and transactions is referred in the above disclosure

In addition, NFA's are defined in the present disclosure as asset-backed securitized tokens and can be traded though one or more platforms and can be customized through the Genisor toolkit to optimize trading for the one or more assets (rarities) that have been created in the past and in the process of creating or just created. The rarity assets will be vetted by one or more Specialists or Rarity Experts and may be listed on the RTP as a singular asset or a pooled asset in one or more ecospheres, exchanges, rarity subclassifications and trading Metaverses and Omniverses. Each rarity asset fund will be registered with the SEC or international equivalent and the system after verification, will securely store information about the asset and record ownership of the asset, all transactions and trading statics (price, open, close, volume, trend analysis, fundamental analysis, technical analysis and other analytics) involving the asset and all data associated therewith that may be needed to be available for one or more requesting entities, investors, specialist, and other requesting entities.

In a subsequent embodiment, the source of GOAT and RTP collaboration platform nodes can include: a first hash value that represents Originator (Genisor Creator) nodes (data regarding the Genisor and GOAT collaborators, and contribution to the project, as programed through one or more locations of the root node), in addition all data (i.e.; notes, process, lyrics, art, design, science, formula, physical color, virtual topography, avatars, holography, a physical size, a quantity, a make, model both intangible and intangible, and all other IP collaborative creations . . . ) associated with an intangible and tangible asset (e.g., a machine or a parcel of land or virtual land in the metaverse, IP creation and one or more macroverses, microverses, onmiverses and metaverses traded on a the RTP platform).

Derivatives and hashes in this embodiment represent a new kind of NFT including but not limited to a new creative introductory construct that can serve as an origin point for users through the Genisor. In this example, while providing Genisor new content creators from collaborators can be considered an infinite source of a versatile network to innovative new projects and a new dissemination and distribution mechanism through the RTP (NFA/NFT) platform.

Further elaboration of the previous embodiment: the RTP ecosystem can be considered as a creative collaborative building block: utilizing fundamental and P2P open and decentralized hash remunerative hash values. These values represent one or more programmable open and closed loop subsidiary nodes. The method also includes off-chain traditional hierarchical hash-link data structures in a non-provisional, one or more processor-readable memory chips. The hierarchical hash-linked tree structure can include multiple trading nodes, since cryptocurrency nodes are a computer, or group of computers working together, that support a crypto network through the verification of transactions and maintenance of the blockchain, or the digital ledger. Information on any of the numerous crypto ledgers is typically distributed throughout a network of nodes.

Some embodiments include storing a hierarchical hash-linked tree structure off-chain and causing storage of a hash value in a blockchain. The hash value can represent an off-chain storage location of a root node of the hierarchical hash-linked tree structure if the new IP creation requires such action. The hash value can also be associated with a state of a smart contract, where the smart contract (inherent to all rarities) includes a representation of an owner of a digital intangible asset and which representation can include the location of the physical (tangible) asset. The method can also include generating a second subsidiary node in response to a modification to the intangible and tangible asset. In some such embodiments, additional hierarchical hash-linked tree structure and location of the physical asset can include the data of the first hierarchical hash-linked tree structure and data of a second hierarchical hash-linked tree structure associated with the intangible digital asset and tracked through the blockchain.

In addition, the disclosure may include other innovations not presently described. Applicant reserves all rights in such innovations, including the right to embodiment such innovations, file additional applications, continuations, continuations-in-part, divisional s, and/or the like thereof. As such, advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

While specific embodiments of the present disclosure have been outlined above, many alternatives, modifications, and variations will be apparent to those skilled in the art. Accordingly, the embodiments set forth herein are intended to be illustrative, and not limiting. Various changes may be made without departing from the spirit and scope of the disclosure.

FIG. 2. 200 is a schematic diagram of the Genisor Management team product Milestone Based Blockchain ledger designed to track and evaluate Genisor product and service progression and deliverables throughout the product lifecycle. 201 (119) represents the overall Genisor Milestone Blockchain Product Development Blockchain model and network based on verifiable deliverable milestones relative to various RTP NewEnt. creations as referenced by 212 and 211 references the Milestone-Based Auxilium Blockchains is defined in the Glossary of Terms Sector in the Summary of Invention. 213 (501/605) refers to NewEnt.'s core team, managers and personnel. In the example, this NewEnt. team has seven team members 208 (TM1-TM6) including the Genisor Manager, however, can include any number of team members in different disciplines any field.

Genisor Milestone-based Blockchains 210 (119) in an embodiment of the present application which provide seven primary business operating data entries; Record entries and log all required organizational documentation needed and required for NewEnt. Genisor Manager(s) and project team members 208 oversight and compliance as exemplified by FIGS. 15, 16, 17 and 18. Operations can include:
1. Recording entries logs as well as detailed in progress data reports for each phase and of NewEnt. products and development milestone-based deliverables and progress reports (growth model) 211 for each step (strategic and technical) relative to forecasted implementation timeline.
2. Record entries and log the GOAT applications utilized as it relates pertinent analytical assessments, recommendations and operational pivots made by NewEnt. and individual team member contributions.
3. Record entries of minutes of board and team meetings and updates and important conferences.
4. Record 3^{rd} party legal documents, restricted data access represented by 204 Non-Disclosure Agreements (NDA), accounting, auditing, SEC filings, regulatory approval 209 (111) tax filings, etc.
5. Record NewEnt. entries listed on Primary and Secondary exchanges 203 as well as its virtual (digital) twin counterpart when rendered as well as financial instruments and all investor transactions 213.
6. Record entries and log finished customer product transactions 203a., 203b, sold through securitized public trading 206a and non-securitized public vehicle offerings 206b data as well as team member renumeration, royalties, revenue and compensation schedules for each team member.

Anyone familiar with the art will recognize that the seven primary milestone-blockchain primary sectors can include one or more additional primary and secondary elements and components. Milestone deliverable timestamps prove that transaction, situation, circumstance and data relative event existed when the block was published to get into its hash. As blocks each contain information about the blocks previous to it, they form a chain, with each additional block reinforcing the ones before it. Therefore, blockchains are resistant to modification of their data because once recorded, the data in any given block cannot be altered retroactively without altering all subsequent blocks. Blockchains are typically managed by a peer-to-peer (P2P) network for use as a publicly distributed ledger, where nodes collectively adhere to a protocol to communicate and validate new blocks.

As previously described in FIG. 1., the RTP (114) platform provides team members development aid and help through GOAT from concept through product introduction and post assistance after launch via a customized plurality of operating tools for any concept, any SIC/NAICS and for all classifications and subclassification of product and service creations as described in FIG. 3

The primary transitional map via Milestone based Blockchain in accordance with exemplary embodiment can include present and future Blockchain technologies such as 5.0/6.0/7.0 etc.

In addition the Milestone Blockchain can utilize the convergence of artificial intelligence (AI) with blockchain technologies, harnessing cyber-physical systems (CPS), robotics, Internet of Things (IoT), Big Data, human-automated system interaction, for automated data entry, etc.

Milestone-based Blockchains components can include: computer-readable storage media, which can comprise CD-ROM, ROM, RAM, EEPROM, or other optical disk storage, flash memory, magnetic disk storage or other magnetic storage devices or any other medium that can be used to store desired Milestone Auxilium program code in the form of tutorials, step-by-step instructions or business management data structures, business fundamentals, strategic logic, and that can be accessed by the Genisor Team's computer(s) after ID.

202 represents a closed network and data restriction as referenced in #5. The above embodiment restriction can pertain to a 3^{rd} party individual, more than one individual, corporation (big or small), one or more team members and one or more organizations from any region in the world. Restricted and closed blockchain access can depend upon the execution of an NDA or other factors including temporal restrictive access based incomplete milestone deliverable prior to the restriction. 203 references an open public access gateway and a reopened private gateway after the restrictions are redacted or covered through an executed Non-Disclosure Agreement.

210 illustrates various stages of Milestone Product and Service development by one or more NewEnt.'s. The color, placement (map) and size of the bubble signify various types of products and services, various levels of completion, various restrictions and various securitizations methods 203a and 203b, etc.

FIG. 3. 300 is a flow diagram illustrating the Rarity Trading Platform (RTP) and ecosystem as it relates to various physical, digital, intangible and tangible IP classifications and subclassification relative to transactional data and analytics in accordance with exemplary embodiments. 318 represents various asset classifications and subclassifications, 312, financial services, 311, Sports Memorabilia as it relates to sports stadium, casinos, galleries, horse racing tracks and other fan sported venues including live broadcasts, 310 movies, video and podcasts, 309 video gaming, 308 eBooks, and 306 Art Collectable Sectors 305 music, 304, virtual spaces, 303 science engineering design and development, 302 real estate (real and virtual), 301 food and beverages, traded within one or more RTP (NFA/NFT) platforms.

In another embodiment, the type of cryptocurrency can vary and the asset in this example is interchangeable. The owner of a French Wine in the Food and Beverage Sector (301) can exchange assets of equivalent value in the RTP ecosphere for example with owners of assets in 328 the retail sector for example. 324 enables both owners to flag their holdings for electronic Swap or eSwap (321 and 320) “eSwap” is defined for the purpose of the invention as the “exchange of ownership of one or more rarity assets within the RTP (NFT) platform” 321 both transactional parties (321 and 320) provide the history of each transaction, transaction hash, block conformation, timestamp when purchased, past gas fees (mining costs), initial purchase price, recent closing price, yield, ROI and other fundamental analysis both (quantitative and qualitative) brand value, the financial performance of the company, management decisions, and other similar factors can be termed as a qualitative approach exemplified by 323.

There are numerous types of collectables and terms to denote a range of value and pricing including appraisal and real-time market value based on demand and financial index types (318 and 325), 326 Defi financial services 312. Financial and Investment industry 319 as it related to RTP milestone blockchains represented by 301a, 301b, 301c, and 301 d . . . depending on the (t) timestamp.

Music and audio for any genre (316) including but not limited to 317, Country, 314, Rock & Roll, 315, R&B, and 313 represents new music genres not yet classified. 304 represents all virtual spaces and virtual creations for the RTP platform or other platforms in the Metaverse, Microverse and Omniverse (307). In addition, 307 represents all creative IP Copyright, patents, branding, trademarks, domain names, etc., and collaborations in the Metaverse traded on a multitude of RTP (NFA/NFT) platforms. 303, includes new designs, scientific discoveries and engineering technologies and resulting development of the new technology including but not limited to the creation of jobs from entities who obtain the licensing rights to the technology. 302 represents Real Estate and Virtual Real Estate which overlaps Virtual Spaces and Architecture. For example, (304), 301, Food & Beverages includes but is not limited to wines and spirits and other food related rarities and species for example. 312, is in reference to new Financial Services and investment trading platforms, IP verticals and DeFi and DApps (326).

In addition, 322 references all types of derivatives developed for all asset classifications. 324 refer is defined in this invention as a contract between two or more parties whose value is based on an agreed-upon underlying financial asset, debt, equity, index, or security, future contracts, smart crypto contracts, market caps, trends, forward contracts, options, eSwaps, warrants, options, calls, puts and all trading products (ETFs, options, futures, IPOs, mutual funds, bonds, etc.). Various derivatives derived assets 322 can be used to either mitigate risk (hedging) or assume risk with the expectation of commensurate reward (speculation), for the NFT (RTP) marketplace, etc. 325, embodies all investment and financial data, all quantitative and qualitative analysis, for all cryptocurrencies, NFA/NFT and related platforms and exchanges. Including but limited to price charts (graphics), volume, hi/low, year-to-year, ticker, yield, pricing, fees, volume, coins, market cap, stats, trending, overview, history, all-time highs and lows and all Technical and Fundamental analysis (319) as well as includes all indexes, trading app stores, web trading, API, mobile apps, order execution for Genisor and Collaborator IP and resulting new organizational entities, Cryptocoins and cryptocurrencies, RTP (NFA and NFT) marketplaces, etc.

In another embodiment, 327 refers to the customization capabilities of GOAT to trading on or the RTP platforms, design, test, optimize, monitor, and automate your custom trading strategies, and order management, trade executions, (324) and other programs and tools designed for new RTP organizations to trade through the ecosystem (328) and other platforms and indexes 318, and 301 (a), 301 (b), 310 (c), and other types of renumeration for all new Collaborators and Genisor(s) exemplified by 301(o) is detailed previously in the above description.

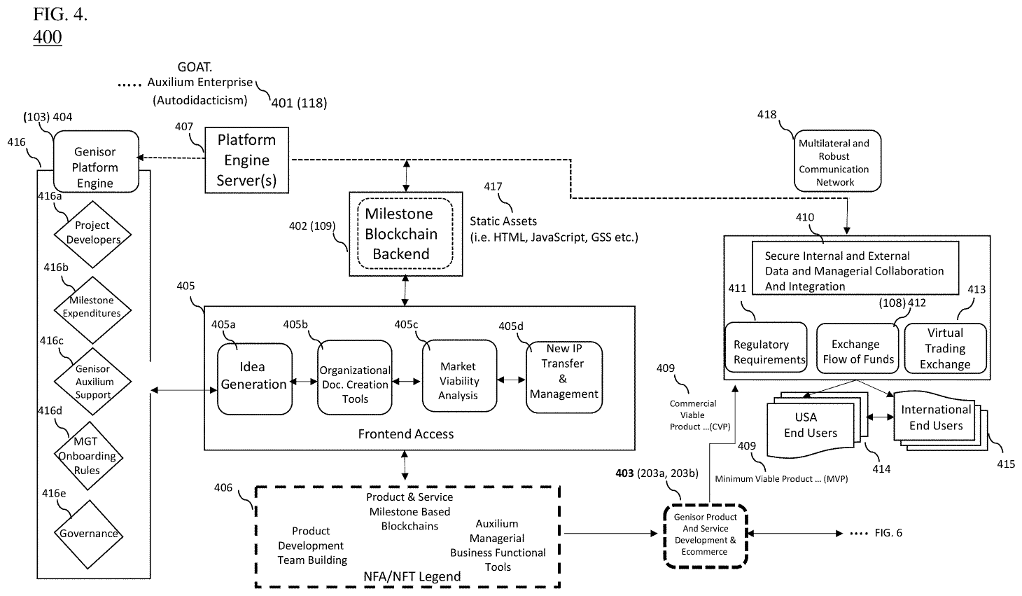

FIG. 4. 400 Is a block diagram illustrating the GOAT process, communication, functions including frontend and backend services rendered to RTP users in accordance with exemplary embodiments. An additional embodiment 407 references RTP platform engines and platform server(s) that include one or more application front-end server(s) that operate as a gateway or intermediary between Genisor NewEnt. and Genisor Specialists and includes resources on a network as well as the interface between investors and customers. Application proxy or front-end server acts as a gateway represented by 405 and intermediary between users and resources on a network or between clients and applications. Genisor Platform engine servers 407 includes a multitude of support applications, components and interaction between the Genisor Manager and secure server. The primary role is to accept incoming requests by forwarding them to one of multiple servers that handle RTP new member (NewEnt.) requests through a multilateral and robust communication Network 418. The RTP frontend server software and platform 405 can include one or more necessary due diligence data entries including but not limited to 405a, Idea Generation and Concept description and question and answer formats. 405b. Organizational documentation tools. 406c. Analytical tools to help in determining market viability, 405d, IP development and transfer (if not assigned to NewEnt.) managerial guidelines and other NewEnt. information.

402 (109) references Milestone Blockchain backend servers that can use 417 static assets non-code files that are directly copied to the build output including images, stylesheets, favicons, fonts, etc. and program codes such as HTML, JavaScript, GSS, etc. and securely held RTP folders on one or more servers. The RTP platform 407 engine server(s) communicate 418 with both internal (RTP's Specialists) and NewEnt. potential external team members and that will manage and operate the organizational entity through GOAT (118). In addition, oversite rules and regulatory requirements 411 and 412 (108) exchange and flow of funds including costs, fees, expenditure outlays and receivables for all operational activity will be entered on the Milestone Blockchain and accessed accordingly when disclosure is required and through the executing of NDA's, etc. are elements of 410 referred to as Secure Internal and External Data and Managerial Collaboration and Integration including 415 the digital twin “virtual trading exchange” in conjunction with “real asset trading exchange” as previously described.

The Genisor Platform Engine 404 (103) component of the RTP and GOAT 401 (118) components and functionality is represented by 416. 416a can include project developers and NewEnt. Genisor Managers. Milestone Expenditures 416b and Genisor advance tool logic and protocols available to RTP members. Furthermore, 416d MGT onboarding procedures and rules of conduct and Governance are addressed by 416e a.

It is understood that an application server consists of hardware and software that enable individuals to create web applications and provide an environment in which to run them. RTP (114) server type hosts multiple instances of an application, which makes it possible for many users to access and use it at once. In addition. RTP (114) refers to it as middleware because it resides between an operating system and software programs. RTP (114) application servers usually perform tasks, such as caching and load balancing, to help Genisor users and NewEnt. obtain a greater degree of consistency and better performance from their web applications. RTP (114) application servers serve many purposes. RTP (114) processors can host a hypervisor, which is a GOAT (118) application of firmware, hardware, or software for creating and running virtual machines. RTP (114) can also process data from a different server and monitor and distribute software updates.

A database server is a hardware and software that connects directly to a database. RTP (114) storage database stores and retrieves data from it and works to ensure that user access to databases and client server communications. The data server functions and provides GOAT (118) resources such as files or applications to end users NewEnt. customers (403) and (203a, 203b) however, the difference is that one of the resources it provides is databases containing large amounts of structured data. Many Genisor NewEnt. asset classifications FIG. 3, such as, video gaming, engineering projects, new programming Genisor enterprises, etc., require an intensive need for storage and retrieval. A domain name server (DNS) is a device or program mainly responsible for translating domain names into IP addresses. It resolves domain names and maps them to specific servers. It can also provide other useful services, such as keeping a cache of pages a user often accesses on their network. RTP (114) and GOAT (118) software can help speed up page loading times as well as reduce bandwidth usage.

The RTP (114) file server is a device that stores files and provides shared access to information and other and other resources on a network, usually a local area network (LAN) or a wide area network (WAN). It makes it easy for users to access and on important documents, video, photos, holograms, metaverse, omniverse, virtual and digital data. 2D and 3D data. In addition, other data from multiple user (DEFINE) computers can be utilized rather than storing one copy of each file on individual systems. The RTP (114) file server can handle thousands of simultaneous connections for data analysis and processing large files. RTP (114) file transfer protocol (RTP) server holds a repository of files and directories on a host computer. It functions as a gateway between computers and their connections to remote servers. Case in point, when a Genisor user, customer, investor, requests access to a file stored on an RTP server, it makes that file available over its connection with other networks and also accesses any new data or changes made to its files through that same connection. RTP (114) can function as an intermediary for both incoming and outgoing information transfers for all ecosphere applications. RTP (114) server allows users to access information located on remote systems without needing special firewall software.

Furthermore, another example of the platform is a RTP (114) gaming server which is similar to a regular server in that it generally runs software and provides various services for Genisor Product and Service Developments for ecommerce as shown by 403 and referenced by (203a), (203b) users in the network or on the Internet. RTP (114) in other embodiments act as a host that coordinates and allows networked players as in this example and those from different geographic locations within the USA 414 as well as international players 415 to play or work together in computer games as well as other Genisor IP created products and service though RTP (114) online applications. A gaming server can assist in bootstrapping a gaming startup. A gaming server can assist in this process and improve the experience and connection of users when they play multiplayer games online to function properly without the gaming server infrastructure metaverses and omniverse cannot interact with one another. RTP (114) mail server's primary function is to send and receive e-mail. It often acts as a centralized hub of communication between individuals, groups, and organizations. A mail server can be an on-site device, such as a desktop computer that a company set up specifically for sending and receiving e-mail, or a cloud-based solution that providers offer their customers. It's common for larger companies to rely on third-party providers to handle their e-mail needs instead of running their own servers. This reduces the risk of downtime and enables them to direct their resources to other business processes.

Other embodiments include 406 services within the ecosphere which includes product and service based blockchains frontend and backend layers, product development skills and team building to develop MVPs 409 and commercial finished goods and services for ecommerce and traded on various exchanges i.e., NFT's and NFA's Legend. In addition, an application programming interface (API) is a way for two or more computer programs to communicate with each other. It is a type of software interface, offering a service to other pieces of software and remote APIs, web APIs, etc.

In contrast to a RTP (114) user interface, which connects a computer to a person, an application programming interface (API_connects computers or pieces of software to each other. It is not intended to be used directly by a person (the end user) other than a computer programmer who is incorporating it into the software. The RTP (114) API is often made up of different parts which act as tools or services that are available to the programmer system and network programmers.

One purpose of RTP (114) processing function is to hide internal details of the APIs on how the RTP system operates, exposing only those parts a programmer will find useful and keeping them consistent even if the internal details later change. The RTP (114) API may be custom-built for a particular pair of systems, or it may be a shared standard allowing interoperability among many systems.

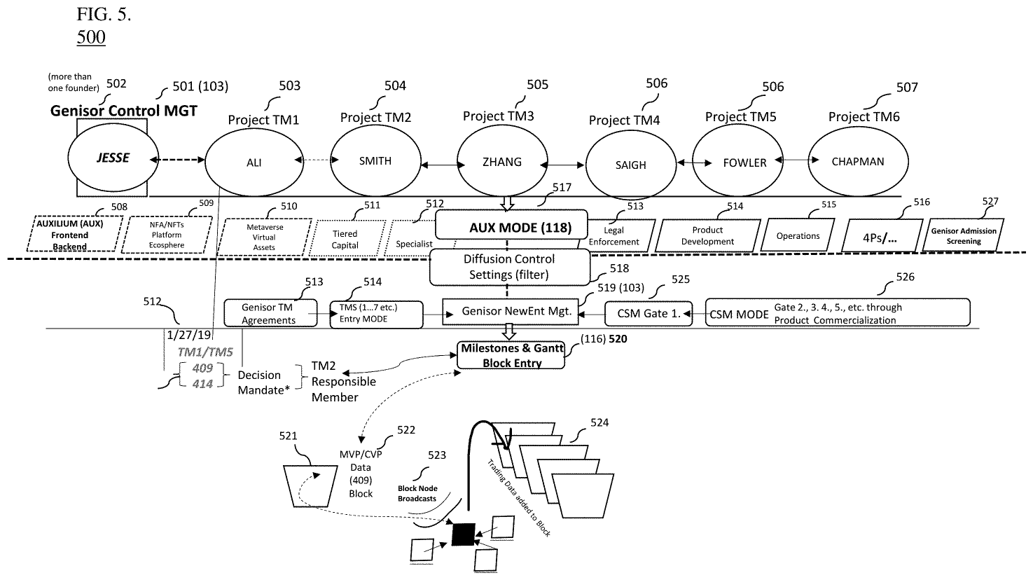

FIG. 5. 500 is a block diagram and flow schematic of the Genisor Controller Management Team System and a plurality of software AUX settings that access various utility product development services on the RTP ecosphere with exemplary embodiments. 602 Milestone Gate 1 represents required RTP. 501 (103) shows the control manager who can in this example be the founder and titled as the CEO. However, any title and job description can be used such as but not limited to: President, Director, Vice President, Director and executives, officers, etc. The control manager founder Jesse 501 in one application example, forms the organization and came up with the product and service idea and concept and identified the void in the market for his product. Jesse 501 then uses the RTP platform to recruit other members for his Genisor team referred to as TM1 (503) Ali, TM2 (504) Smith, TM3 (505) Zhang, TM4 Saigh, TM5 Fowler, TM6 Chapman.

The RTP platform enabled Jesse 501 after Jesse registered the organization and after Jesse received a Unique ID for himself and his Genisor NewEnt. to solicit and accept job descriptions relative to his search. The RTP (114) can utilize an inhouse (HR software as well as other provided software) search query to access, communicate bios criteria person with experience and skill levels Jesse is looking for as a member of the project team by means of various frontend and backend GOAT (118) applications as detailed in FIG. 4. 502 refers to more than one founder of the NewEnt. In addition, the NewEnt. can consist of one or more existing organizations that in need of capital and other resources and services offered by the RTP platform and ecosystem. 508 refers to various functional services and application the GOAT Auxilium software (AUX) 118 provides such as NFT/NFA trading access 509, Metaverse applications 510,

Tiered Capitalization based on Milestone deliverables and accomplishments 511, Specialist services 512, Legal documents and enforcement services 513, product and service development applications 514, marketing, social network, promotion services, pricing models, distribution and logistics and related applications 516, Genisor managerial software such as scheduling tasks, team video meeting and conferences, document sharing, document creation software, administrative software, clerical and secretarial service software, event management software, CRM, web builders, automatic payment & renewal workflows, mobile app. development, software development tools, and all other operational GOAT tools and services, video conferencing, information technologies, technical and fundamental analysis programs, customizable learning tools and resources to optimize creativity as exemplified by 515. 517 refers to an example of team member Zhang (TM3) who is assigned to arrange and communicate team member goals and tasks for each milestone deliverable and AUX mode.

In addition, AUX Mode 118 refers to customizable control settings 518 and preferences including filters to eliminate, expand, detail and assign specific tasks to team members for Genisor Mgt. 519 (103) milestone deliverables timestamped blockchain entries 520 (116) milestone deliverables.

513 refers to NewEnt. team member agreements for each team member 514 as entered on the Milestone blockchain and GOAT software settings component referred to as Common Service Management settings (CSM) 525, relative to Milestone Gate 1 entry and as detailed in FIG. 6. For example, GOAT mobile app's CSM setting modes can provide the framework for each Genisor Milestones i.e., Gate 1 525 and subsequent milestone gates and deliverables from product inception through commercialization and beyond 526.

512 refers to the due date of the deliverable documents required by the RTP and potential investors. In the illustrative example, Team Members TM1 and TM2 are the responsible members for this task. Milestone and timestamp deliverable due dates block 521 entry is referenced by 522 and can include informational progress reports on MVP (Minimum Viable Product) and CVPs. (Commercially Viable Product) 523 refers to completed Milestone Gate (further detailed in FIG. 6.) which can broadcast block nodes when entered as well as broadcast nodes for CVP trading 524.

FIG. 6. 600 is a block diagram illustrating required information for RTF onboarding, policy terms, and deliverable milestone requirements, valuation and deliverable assessment and blockchain entries in accordance with exemplary embodiments. 602 (405) and (406) include an embodiment referred to as Milestone Gate 1. Which signifies the first step of Milestone RTP onboarding (a.) and for two primary purposes: 1. planning, procuring and establishing both organizational documentation and credentials and 2. quantitative and qualitative deliverable milestones for product and service development as well as verification documentation of both. Other Milestone Gate 1 deliverable components include b. Management identification, c. Organizational identification, d., Team Identification, e., Team member legal acceptance of rules of conduct RTP platform governance, and can include Gantt charts product development scheduling requirements, g., research and development, h., Organizational Start up documents, Q&As, NewEnt. executive summary, business plan, marketing plan, strategic plan, financial plan, product and development plan, proforma, website, domain name, geographic physical address for each team member, offering memorandum, Private Placement Memorandum (PPM), IP, registered brand names, copyrights . . . as sited for the purpose of brevity.

605 signifies that every requested document was provided by the NewEnt. and entered the Milestone Blockchain. 603a breaks down and details each Milestone Gate 1. Entry such as for example. Heading: Gate 1 Final Genisor Milestone Blockchain Data entry as referred to by 616 Genisor Auxilium Blockchain Entry Stage I series entry . . . (New Enterprise Gate I.) referenced by 603a:

Step 1 NewEnt. include for example, sign up documents and legal agreements crucial for the foundation and organization of the NewEnt
Step 2 documents pertaining the configuration and design of the product
Step 3 private and previously published documents, new articles and podcasts
Step 4 team member titles, roles and responsibilities
Step 5 MVP development and the bios of each team member

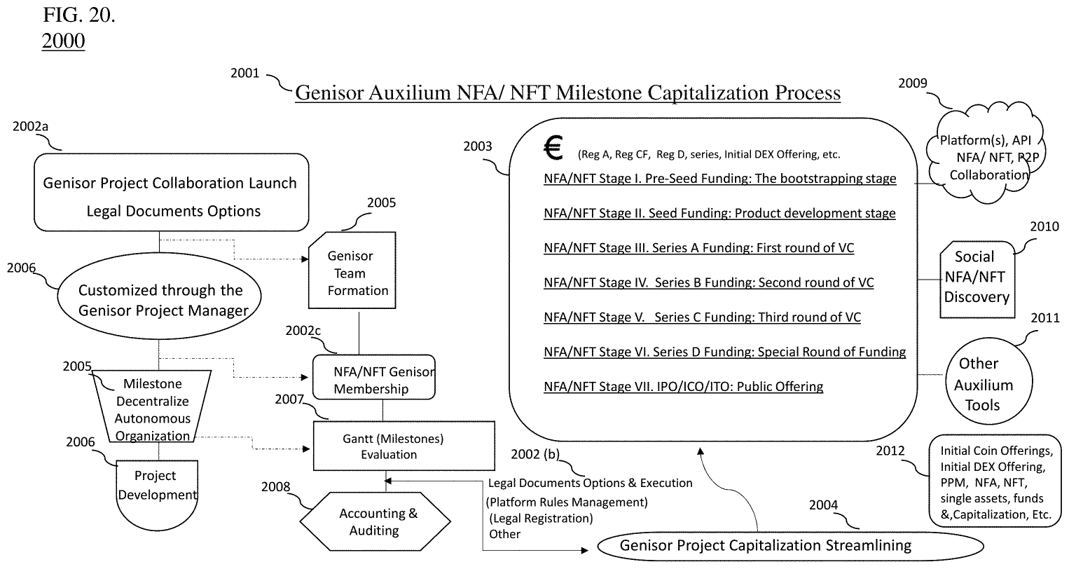

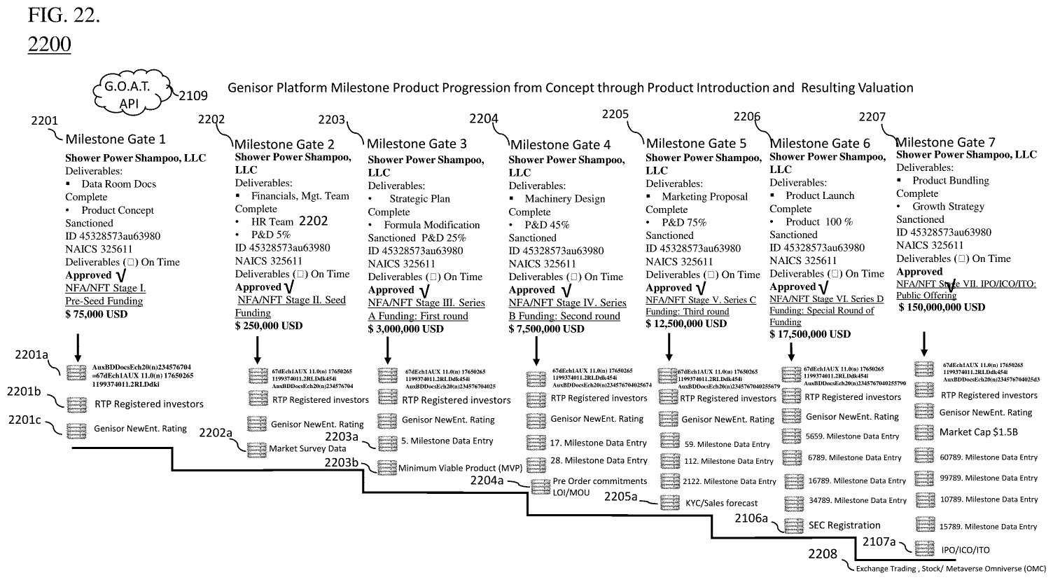

606 exemplifies NewEnt. submission for seed capital from one or more RTP investors and corresponding RTP's posted approval of the Pre-seed Capital Funding approval for Stage I. FIG. 22 further exemplifies stage capitalization based on Milestone achievement models. 616 represents Milestone Blockchain Entry and funding capitalization for all milestone-based Gates are detailed by FIG. 20.

604 references the subsequent Milestone Gate 2. Milestone Gate 2. Details the progress of 618 (product development), capital expenditures, financial appropriations from Gate I pre-seed capital and pitch updates, new presentation materials and documents, changes in product development (Pivots) updated PPMs and capitalization projections, new product development features (618) if any, and other human resource requirement. As previously described in the present application, GOAT software can provide all of these functions and more including filling the human resource needs of NewEnt. with experts and mentors referenced by 608 on the RTP platform, etc.

603b refers to weight averages and performance ranking (WC, RW, IR., CPD) as well as their pertaining weighted averages 609 for each deliverable. For example, all passed minimum evaluations with the exception of the failure of the Business Mkt. Analysis, PPM documents, and Product delivery functionality where the rankings were deemed below standard or not performed. 610 exemplifies the reason, description and analysis of the failure of NewEnt. to go to the next round of capitalization (Stage II). 610 Genisor Evaluation details the failure as transcribed: 1. Team Member 4 was not performing to standard and the NewEnt. team did not meet goals and deliverables within the set timeline. [000346583982985auxperffailur] block entry node. Team Member 4 was responsible for Product Market testing, 2. QQC, 3. [0003465839829856f487auxTM4Resps.] block entry node continued. Resolution Options 1. Utilize Genisor HR specialist replacement 2. Hire replacement for Team Member 4. [0003465839829856f487auxsolGoat_HR] 614 Genisor Block Entry. In this example, NewEnt. Team Member Four (4) did not meet the assigned tasks required by the Genisor Control Manager. The Genisor Control Manager utilized the GOAT application's recruiting software to post the post the position. The posts included experience, education, responsibilities, timeframe, timeline, job title, location (remote and a combination of a specific location) and other recruitment criteria. The RTP circulated the position within the platform and externally through Meta (Facebook) Instagram, LinkedIn, etc. Hundreds of responses were received from all over the world to fulfill the position. The GOAT accessed a plurality of social media API's and used its HR processor to list potential applicants, schedule remote or on location interviews for all candidates that passed the initial GOAT AI qualification screen, which, in an embodiment, verifies, identifies and helps qualify and trace specific applicant responses. In addition, GOAT, through the RTP NewEnt. Control manager, narrows down the most qualified candidate for the described tasks. Team Member 4 then was chosen from the list of candidates and provided an RTP Identifier and team member 4 biography and responsibilities. Such a biography includes entity agreements, complete background check, etc. Furthermore Team Member 4 was informed of and agreed to “RTP rules of Governance, Compliance, Renumeration” and specific roles and tasks that are stored and logged on the RTP platform as well as entered on the platform's Milestone Blockchain. However, after Milestone 1 was completed and NewEnt. was partially capitalized, the Genisor controlling Manager through GOAT and the RTP system assigned each team member with a new set of tasks and deliverables. However, after evaluation by the Genisor Control Manager with other team members and the assistance of GOAT deliverable evaluation from Milestone Gateway 2, it was discovered that Team Member 4's performance, scheduled task completion and resulting deliverables were inadequate and not performed and to standards In addition the tasks assigned to Team Member 4 did not meet the completion timeline and as a result FAILURE BLOCK [000346583982985auxperffailur] block entry and identification (ID) of Team Member 4 was logged as well as the description of the assigned tasks and circumstances leading o team member 4's removeable from the Team. There can be many reasons for such a situation.

612 references and example of the GOAT time scheduling software and 613 refers to the actual time delay the failure caused (12 days). 615 refers to the alert notifications sent to all investors and required parties. The RTP AI and other analytical tools and programs used for data analysis are also entered and accessed (if permitted or required) on the Milestone blockchain 616. 617 (111) refers to the RTP stage funding capitalization process on (NFAs and NFT exchanges and other financial exchanges).

FIG. 7. 700 Is a block diagram illustrating scalable and adaptable decision-making software for Genisor Control Managers and team members in accordance with exemplary embodiments. In one embodiment referenced starting with 701 (114) signifies an NewEnt.'s Genisor Manager which could be a single proprietor, a sole partnership, corporation and organization, private company limited by shares, private company with revenue sharing or other forms of renumeration, public limited company (PLC), virtual limited company (VLC), limited partnership, general partnership, holding company, limited liability company, subsidiary company, branch operation, S corporation, C corporation, contractual joint venture, international organization, non-profit organization, governmental entity, state entity, local entity, etc.

In addition, one or more NewEnt. can be listed in one or more exchanges and of any financial and investment vehicle either as a single asset or a pool of assets, a managed asset or an unmanaged asset, stocks and equity, bonds and debt instruments, mutual funds, fiat and cash, exchange traded funds (ETFs), bonds, cryptocurrencies, commodities, real estate (REITs), derivatives, CDs, corporate bonds and treasuries and government issued securities, virtual securities, annuities, insurance policies, IRAs, 401k, ROTHs, etc.

Furthermore, the RTP exchange and licensees can include financial advisors and wealth managers (these include Certified Financial Planners or CFPs, Chartered Financial Consultants or ChFCs, Registered Investment Advisors or RIAs, registered broker-dealers and stockbrokers), etc. In addition, RTP or their licensees can combine any form of investment vehicle, any form of ownership, any form of remuneration and royalty (sweat equity, performance measurements, stock, warrants, options, revenue sharing, profit sharing, promissory notes, etc.) foundational organizational structure best suited for the enterprise, product and service classification and member's objectives as well as NewEnt. development phase when listed on the RTP. The Genisor Platform can include auxilium assistance in all aspects of establishing the said organizational foundations and well as dynamically change various components contractually when requested by the NewEnt. Manager or whenever Genisor's AI discovers mismanagement, misappropriations, fraud, oversight issues through the breach of the rules of Governance and Genisor platform rules agreed upon contractually prior to RTP membership.

Additional embodiments include: RTP ecosphere and platform can provide guidance, software, forms, tutorials and other Auxilium tools for matching optimal organizational structures best suited for the type of entity and product and service provided. GOAT can also provide services such as robo-trading (AI/M2M) and dashboard trading fundamental and technical assistance tools, value proposition models and other financial and investment data and SEC or its international equivalent rules and regulations and statues.

The GOAT communication platform can also provide policies, principles, rules management, procedures, practices, methods, techniques, skill sets (Specialist, i.e., mentoring, field experts and consultants, essential support, indirect support, systems support, aid and assistance, scheduling support, sales and marketing support, capital and funding support, human resource support, social network access, intellectual property (patents, copyright, branding trademarks, registered trademark logos, etc.) document creation and sharing, organizational charts, logic, team member task assignment, secure communication and other decision making tools.

GOAT Decision Making Operating Tool(s) and Methodology An embodiment of the present invention includes the assignment of P&D tasks between one or more team members in NewEnt. best suited to perform the task as reference by 701 team member 1-7. 702 identifies each team member of NewEnt 701. with a unique ID code 702 which serves several purposes including but not limited to an organization's decision-making process made by NewEnt. After request, 707 is created and entered to the RTP through one or more GOAT API's conjunctionally with the NewEnt. identification entry 701 which could be through one or more team member biometric identifiers, passwords stored processed on RTP platform server(s).

Furthermore, one or more team members can request commands from the RTP process server and API 707, after identification confirmation occurs from the RTP server processor 702, GOAT decision management tools utilizing AI and machine learning as well as RTP Specialist and 3^{rd} party advisors as depicted by 708 can initiate the GOAT assistant software tools and apps and decision-making process.

GOAT decision-making process can utilize AI (M2M) 708 and various assistance modes and tools specifically devised for a multitude of different products, services and fields. For example, a general decision-making process can include data, resources, referrals, news and other information to help the Genisor Management team to:

Step 1. identify the problem (list problems they need to solve in this step)
Step. 2. gather information (learn about different options in this step)
Step. 3. identify alternatives (make the best choice, act, and evaluate)
Step 4. identify alternatives (decide what NewEnt. options utilizing advanced prediction GOAT analytical software)
Step 5. Predict the immediate and long-term implications and consequences (list the pros and cons, SWOT, of options in the step)
Step 6. (709) Make best choice (decide which alternative is best for NewEnt.)

709 Step 6 as referenced by 712 and another embodiment of the present disclosure presents a unique sliding and adjustable decision method where one or more team managers and team members, board members, project team members, legal third party Specialist, for example and investors by proxy, etc. can dynamically evaluate various decisions during the development process as it relates to (τ)·time. For instance, given the hypothesis scenario that Milestone Gate 1. was successfully achieved and entered on the Milestone Blockchain, NewEnt.'s management during Milestone Gate 2 discovered that a team member did not perform an operational task as shown in FIG. 6. (618).

NewEnt. Management contractually has the legal right to remove the non-performing team member. The Genisor RTP platform in this scenario is notified. The contractual terms were not only signed by team member FIG. 6. (618) but in this case the terms were set by the Board 717 and entered on the blockchain 704 after the performance valuation was flagged and quantified 706. The NewEnt. team manager 701(114) as well as the Genisor's board of Directors 717 previously established rules of engagement and performance with the team member FIG. 6. (618) in question for this vary situation. The procedure to methodology removes a non-performing team player was made earlier as presented by 709 when the RTP GOAT software enabled the initial Genisor manager whom first established the concept and idea signed on to the RTP platform 701(114). The lead Manager of NewEnt. 701 utilized GOAT's decision-making tools which assisted the manager to evaluate performance 706 and notify RTP stakeholders, investors, partners and users (both specialists associated with the RTP platform as well as product consumers) if the product and service was commercialized for example. Each request 703, each decision 704, each evaluation relevant to the decision 705, all performance criteria and measurements 706, can be entered on the Milestone Blockchain not only to record transactional data, but to record significant events, significant environmental situations, problems and methodology for decision making.

In addition, decision making with GOAT software can allow and especially specify the gamut of NewEnt. Operational decision making such as: scope, range, time, major, breath, length, detail, decisions of primary importance as well as minor decisions through a 713 scaling decision making process and formats for one or more decisions through the Milestone product lifecycle. Furthermore, 713 (GOAT decision making tools and resources) exemplify that decisions can be pre-programmed: 1. throughout the organization's startup through commercialization and (Milestone Gate (s) deliverables obligations, 2. can be adjusted to various hierarchies of authority from totally autocratic and centralized to totally democratized through voting. 3. Can be predetermined or dynamic or to any degree thereof. 4. can consist of one or more degrees of authority throughout the organization i.e., team member voting every decision 720 or totally assigned and made by a 3^{rd} party 718 such as Genisor Specialists and the Team leader solely 717 or any combination of in cooperation. 5. includes a decision-making scale 713 which can adjust to various elements for all types of problem solving, events and situations for example 713 utilizes the Genisor Decision Making MGT tool's programming code to specify 716 one or more “Special 2.” situations specifically required for a decision by the 720 team members and decision limitations they must adhere to as a component and variable of the overall decision-making architecture as described by the above embodiment. Decision making can be in tandem to a timeline sequence and synchronous, as exemplified by the steps, as well as asynchronous.

In addition, 711 GOAT AI, M2M, manual or a dynamic mixture of all can, if requested, utilize mathematical decision probability analysis, algorithmic models and statistics, vectors and trajectories to assist Genisor managers and decision makers.

The GOAT system 711 can utilize several ratio probability outcome scenarios depending on the type of organization, business classifications, objections, and tasks. For example: For instance, the formal expression of conditional probability, which can be denoted as P(A\B), P(A/B) or PB(A), can be calculated as: P(A\B)=P(∩B/P(B). P(A∩B)=P(A\B)*(B) or P(A∩B)=P(B/A)*P(A) *here P(B) is the probability of an event B, and P(A∩B) is the joint of both events. On the other hand, we can estimate the intersection of two events if we know one of the conditional probabilities (P).

Given the nature of the model, a multitude of decision-making probabilities can be used based on a multitude of variables and conditions. Step 7. (711) (implement NewEnt. decision) refers to the utilization of GOAT to determine the optimal decision for each element of managerial tasks as determined by NewEnt. GOAT enables NewEnt. with an added layer of experience, skill sets and assistance which is often lacking for organization of any size, whether well-established or a new enterprise. Milestone-Based Auxilium Blockchains can immutably record and account for any element of decision making required by one or more organizations no matter the size, revenue, number of employees and type of industry.

In addition, the current structures of blockchains as described in the present application's background segment are rigid, limited and confining. Milestone-Based Blockchains 714 can be dynamically adapted to the organization's goals and objectives, budget constraints, complexity, detail, processing speed, gas fees and designed to rapidly conform to changes in the environment such as government policies, compliance, security and other criteria.

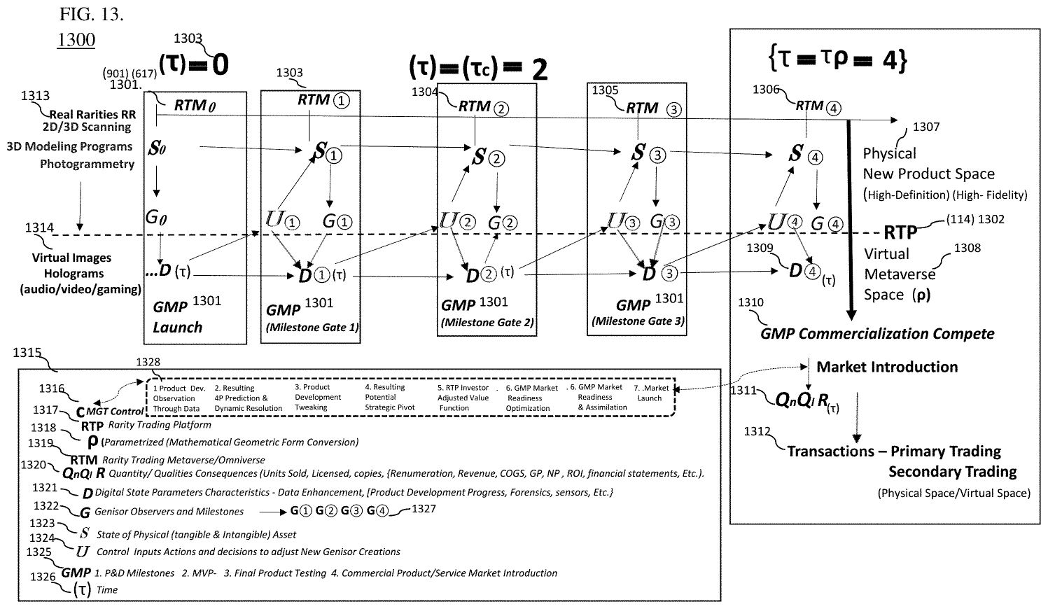

FIG. 8. 800 is a high-level graphic illustration of secure primary and secondary trading of created physical and tangible assets on the RTP exchange as well as supporting software for fundamental and technical analysis for both real and virtual marketplaces in accordance with exemplary embodiments. FIG. 8. and FIG. 9. Technology is detailed and further described in FIG. 13. A flow diagram illustrating a mathematical conversion ratio as an exemplary method to convert physical images to digital and virtual assets.

In an embodiment, real, actual, tangible, intangible and physical assets are digitized and a 2d and 3d high definition-360, photo, video, graphic, audio and visual signals, textures, typographies, light, backgrounds, IR frequency, microwave radio waves, electromatic waves higher or lower than 8×1014 Hertz (Hz) equal to one event per second and can and can repeat the number of occurrences per event can be captured, measured, counted, and mapped for any asset by the GOAT software and listed on the RTP and defined the broad term of Vettenization in the glossary of terms in the Summary of Invention. In addition, FIG. 8 is further described by FIG. 19 which represents the NewEnt. Genisor's hardware, software, firmware equipment requirements as it relates to Genisor asset whether the asset is: 1. rare, old and of high-value, 2. medium-to-low value, 3. newly created or in process of being created and how potentially the asset can change over time; evolve. In other words, no asset is static, physical assets change over time: a classic car can be scratched and the mechanics not well maintained for example, a classic car value can escalate if previously owned by a famous person, a newly created violin and guitar and other musical instruments can grow in value based on the quality of music composed and stars playing the instruments, a shampoo and commercial product as exemplified in FIG. 22 can reformulate to enhance market acceptability, branding and a competitive advantage. The same logic exists for all asset classifications and subclassification.

In other words, NFAs/NFTs can list and trade images of physical assets, real-estate parcel, music and sound, a commercial shampoo, a piece of art and art asset, mechanical item, electronic item, industrial asset and thousands of examples can be described. However, each asset listed on the RTP must be thoroughly vetted, appraised, certified and endorsed by Specialists (defined in FIG. 1.) when entered in the database.

The Metaverse and Omniverse enriches the usability of the asset, the value of the NFA by enriching the item with (Vettenization defined in the glossary of terms in the Summary of Invention) in the above application.

In other words, enriched information can include any RTP-screened asset developed or in the process of being developed by Genisor NewEnt. 801a. exemplifies various Genisor virtual environments and augmented environments options and displays chosen by Specialists for a Business-to-Business (B-B) application and various virtual and augmented environments options chosen by NewEnt. Managers for specified uses for their customers, buyers of the product and services for instance.

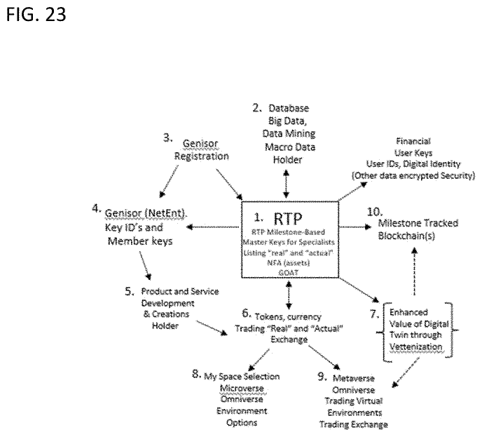

The Metaverse and Omniverse as represented by 801(a) (617) asset listing and can be best represented by a general example of the breadth and depth of the operational process as it relates to the breadth of the RTP and asset trading through the asset lifecycle, traditional asset trading and exchanges through assets traded as the digital twins on various Metaverse and Omniverse continuums as shown by the following and in FIG. 23:

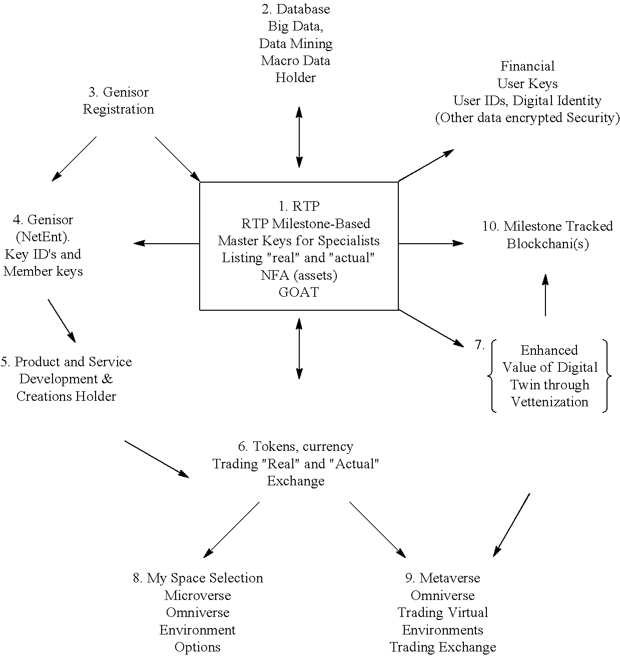

1. The Rarity Trading Platform where embedded milestone-based Master Keys for Specialists and other experts evaluate assets prior to listing on the RTP exchange.
2. Refers to the data acquired through various inputs as previously described by Vettenization, trading, GOAT, and other data inputs and secure access.
3. References Genisor Registration of the NewEnt. and team members in the organization. After RTP confirmation, the organization will be enrolled and have access to the RTP platform and GOAT (as defined in the Glossary of the Summary of Invention).
4. Refers to the Genisor's team assignment and access of an ID access key.
5. References the Milestone Gate Product & Development ownership rights and Genisor NewEnt. holding including all intellectual property, (106) SEC registration, assets revenue, etc.
6. References asset valuation through one or more indexes, appraisers and Specialists which are used to securitize tokens. In other words, vetted assets will create real value instead of speculative valuations and “Monopoly Monetary” valuations that has destroyed confidence in the crypto marketplace because of the vettenization process in the platform.
7. References Enriched data that is gathered for every asset and can be accessed by both RTP Specialist (B-B) with Milestone Based Master Keys and accessed by Managers to track P&D and trading assets through NFAs/NFTs. Both RTP Specialist and Genisor managers and team members can add enriched 803 (103) “Vettenization” (803) information to the Milestone Blockchain.
8. References Real Rarity (RR) location asset tracking) and both primary and secondary NFA/NFT exchanges.
9. References the assets virtual twin traded in virtual environments such as the Metaverse and Omniverse.
10. References Milestone Gateway access for Specialist, Investors, Consumers, Auditors and Oversight and Governance Committees and Government official (SEC) etc. a combination of public and private keys will be used. For example, NDAs will be used for all 3^{rd} party access if required by NewEnt. Managers prior to 3^{rd} party or public access and to the degree of public domain information released. Historical records, ownership, title, certification and developmental documentaries can be stored on RTP one or more APIs and logged on Milestone Gateway Blockchain(s).

801a., 801b. (617) refer to the display asset in a multitude of environments and virtual spaces (user account information) where 802 Virtual conversion (OMC) technology (detailed in FIG. 13) are immersed for trading, exchanges and the integration of enriched data. 804a (103a.) imbeds “actual” asset with the one or more Metaverse and Omniverse virtual environments. In this example, we show a classic automobile asset 808 immersed in a virtual garage 801a and 801b. However, it's one example of thousands of other assets to reference all with different underlining uniqueness' and optimal metaverse trading environments. 809 illustrates an example of a financial and investment dashboard with one or more assets (808) price, trading volume, opening price, closing price and other fundamental and technical data. In addition, a user can use a mouse and point to obtain financial data and point to one or more assets to add other financial data and valuations.

In addition, RTP users, customers, investors and RTP Specialists can point the mouse to the garage icon to receive all the classic automobile financial and investment data. Furthermore, it is obvious to anyone familiar with the art that similar processes can be used for one or more assets in one or more asset classification(s) and subclassification(s), for more than one account or many depending on access key level and can be accessed on one or more devices including, cellular, laptops and virtual Reality goggles. In addition, the RTP asset could be displayed and access in real-time (near-time or scheduled time) environments such as a casino, museum, art fair, mall, gallery, sports stadium, track, parade, tradeshow, convention (topography, geography and location, facility, landscape) for any situation and event. 806 illustrates the “actual asset”, 805 the digital asset and 804a both forms of assets in the metaverse and omniverse setting. 807a illustrates various types of virtual topography, color option settings and display size, display placement, audio choices, transcription styles, translations, close capture and other features. In addition, RR Location feed 810 illustrates a live feed from one or more locations where the asset is domestically or globally located.

FIG. 9. 900 Is a high-level graphic illustration of secure primary and secondary trading of created digital and intangible assets on the RTP exchange as well as supporting software for fundamental and technical analysis for both real and virtual marketplaces and exchanges in accordance with exemplary embodiments.

In similar fashion to FIG. 8, FIG. 9. illustrates My Space options 901a., 901b. (617) refer to the display asset in a multitude of environments virtual spaces where 902 and Virtual conversion (OMC) technology (detailed in FIG. 13) are immersed for trading, exchanges and the integration of enriched data. 904 refers to the conversion of a physical “actual” asset with one or more Metaverse and Omniverse virtual environments, in this case a museum/gallery. My space can also be my home's living room or any other virtual space. The illustration exemplifies a direct real-time (near-time) video feed of artist (NewEnt. Genisor) working on the asset 910.

The captured video feed can be used for asset verification, certification and identification. The Artist in this example can represent any NewEnt. Genisor and any Genisor product & development classification and subclassification. 908 illustrates in this case the art immersed in a virtual museum 901a (617) and 901b. 904, however, is one example of thousands of other IP assets to reference all with different underlining uniqueness' and optimal metaverse trading environments as referred to in FIG. 8. 909 illustrates an example of a financial and investment dashboard with one or more assets referenced by (908) including but not limited to price, trading volume, opening price, closing price and other fundamental and technical data. 909a.and 909b.differs from the asset example used in FIG. 8 since the Genisor NewEnt. creates a series of individual assets, in this case a painting that is physical and converted to digital.

In addition, however the presented application in an embodiment further expands the breadth, depth and scope of GOAT can house on its platform digital representations using 3^{rd} party software such as Adobe illustrator and others software apps. In addition, the RTP platform could integrate third party applications and devices such as for example, Android, iOS, CAD software, QuickBooks, Lexus-Nexus and other third party financial trading apps., Virtual Reality goggles, search engines and crypto tokens and cyber security technologies, communication apps and other required equipment for various product developmental tasks and functions as further described by FIG. 19.

905 the digital asset and 804a both forms of assets in the metaverse and omniverse setting. 907a illustrates various types of virtual topographies, color option settings and display size, display placement, audio choices, transcription styles, translations, close capture and other features. In addition, RR Location feed 910 illustrates a live feed from one or more locations where the asset is domestically or globally located. 911.

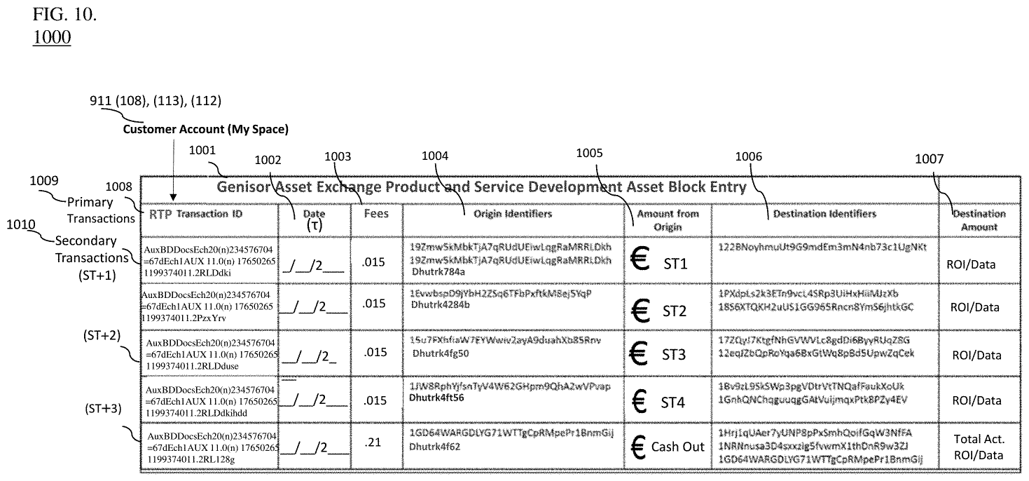

FIG. 10. 1000 Is a chart illustrating RTP investor data transactions and customer accounts and financial data fees through original and destination identifiers and transparent storage via blockchain in accordance with exemplary embodiments. 1001 referees a milestone-blockchain Genisor Asset Exchange Product Service Development hash entries and can exemplify RTP transactions as linked to NewEnt. ID's and investment trading on the RTP exchange. RTP Primary transactions 1009 and RTP secondary trades i.e., 1006 destination identifiers (clearing house) exchange and destination amount 1007 are recorded and linked to the time and date 1002 of the transaction, fees 1003, 1004 Origin Identifier (name, ID of title primary title holder title holders) and broker/dealer, advisor, trust office etc. and secondary, tertiary etc. as represented by ST+1, ST+2, ST+3. 1005 historical data such as base investment (original amount of share price) Investor information also can be accessed by title holders, fiduciaries through private keys. General financial and investment data i.e., stock price (closing, opening, volume and fundamental and technical analysis etc.) can be opened using public or private keys and closed or open loop systems.

In addition, 1005 includes means of repurchases and methods for closing the account, all types of financial vehicles, any exchange associated with the RTP exchange and platform.

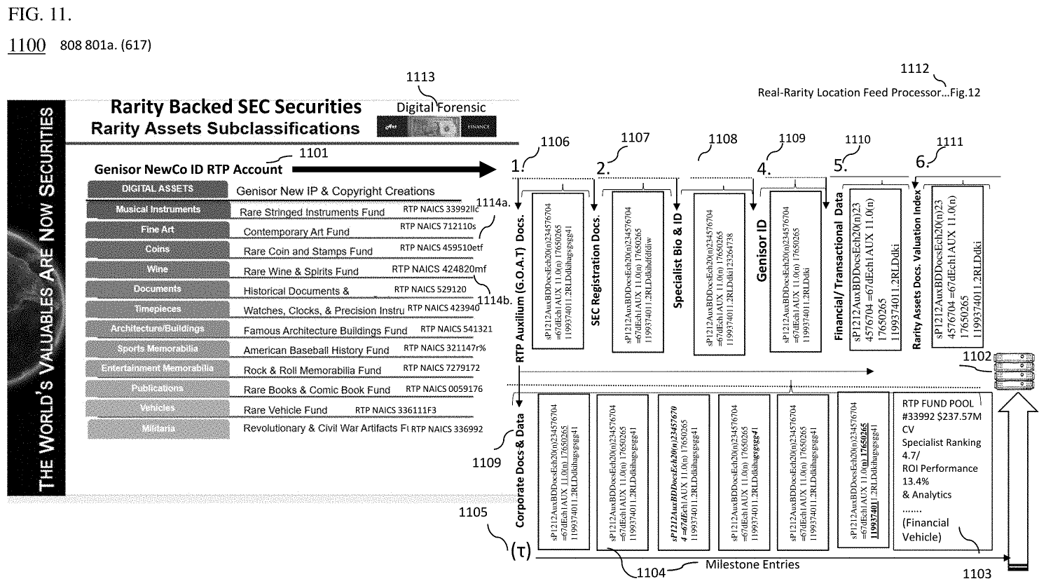

FIG. 11. 1100 Is a block diagram of rarity-backed SEC securities as represented by a plurality of managed and unmanaged financial vehicles for one or more non-fungible assets in accordance with exemplary embodiments. 1114a and 1114b represents various managed and unmanaged financial and investment fund of various vehicles such as managed and unmanaged ETFs, mutual funds, funds to funds, stocks, bonds and all derivatives, etc. 1101 illustrated various RTP rarity assets and physical and digital product asset categories. 1106 refers to various Genisor financial accounts configurations such as all SEC documents 1107 in the RTP platform, a master key for all Specialists who manage their rarity fund 1108, all Genisor ID's 1109, all asset documents and their total value amounts 1111, etc. 1103 represents each RTP rarity pool performance data (statements, ratios i.e., ROI, RRR, QR, CR, etc.) and 1112 represents a GOAT location tools to map the location of the “actual asset(s). 1113 includes the ownership history and authenticity information (vettenization). 1104 refers to QR links and APIs as well as Milestone Gate access for each account (Private Master Key-ID) and timestamping of access date, etc. 1103 also includes future access indexes and tables of content data.

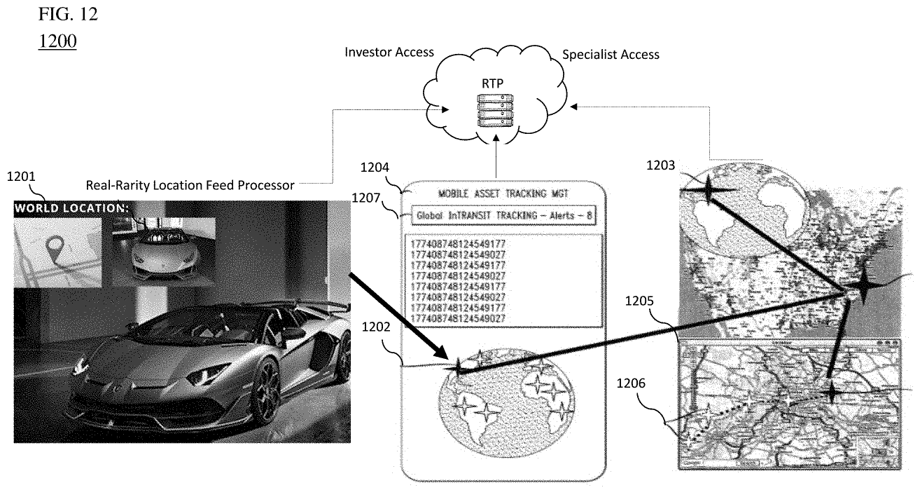

FIG. 12. 1200 Is a graphic illustration of mobile tracking sensors and global location trackers retrieved by the RTP processor and securely accessed by Auxilium Specialists, Investors and Genisor Managers in accordance with exemplary embodiments. 1201 refers to GOAL Mobile application software and FRID, GPS for Physical asset tracking and remote monitoring relevant to the RTP platform and Milestone Gateways physical asset safety and procurement. NewEnt. product can be of physical and tangible nature and creations such as: paintings, violins, string instruments, time pieces, automobile, building and documents, memorabilia, wine and spirits, coins, stamps and other old and newly created collectables. Investors, Specialist, and Genisor members, buyers and users can track one or more asset throughout the World and when in transit when online via mobile device and through other devices and applications. 1204 represents a live tracking locator for all RTP assets, 1203 the XYZ coordinate, and 1205 and 1206 represent one or more synchronous or asynchronous GOAT software access enablers. 1207 includes a consolidated historical log of all the whereabouts of all RTP assets listed on the platform. 1201 also can enable a live video feed and live profile of every asset via the metaverse and omniverse through the RTP process as detailed in FIG. 1.

FIG. 13. 1300 Is flow diagram illustrating a mathematical conversion ratio as an exemplary method to convert physical images to digital and virtual asset twins with the integration of enriched data in accordance with exemplary embodiments. The purpose of this Milestone-based mathematical tool designed for the GOAT is to create a new standard for high-value physical assets in order to enrich the value of the asset. In other word “real physical assets” have its own unique properties and important to investor and customer valuation, however these images and 2d sounds present limitations. The conversion of 3D images and sounds add to asset value but present cons as well converting assets, to 2D-3D-images and sound in their present state to immersive virtual reality and furthermore allowing the asset user, investor, NewEnt., Manager and consumers to experience the assets and objects in various states not only enhances the value of the assets but aides the user with infinitely more data and knowledge including functionality and use cases of the asset, whether the asset start out in physical form or digital in nature, what state and process the asset is currently in, whether tangible and intangible, digital or physical.

GOAT as presented in FIG. 13 explains the physical to digital asset workflow through a series of progressive Milestone Gates and processed-based on asset development time flows. 1313. UHD-Photos and ULHD-Videos are taken from both mobile phones and special digital cameras. GOAT Image-based modelling technique are then incorporated for point cloud generation (with Regard 3D). 3D mesh has been generated and optimized from the obtained point cloud and later uploaded online for public sharing and visualizing in AR/VR. The development of interactive visualization in a Mixed Reality of MxR environment has been achieved with a Goat gamification engine application. GOAT applications aim to help users to understand the methodology and follow the workflow to produce image-based 3D models, share them online, and experience the digital assets in VR/AR and even in MxR environments.

For instance, in one scenario a new violin is made by an Italian NewEnt. the maker of high-quality violins. NewEnt. is a member of RTP and utilizes GOAT conversion technology and leases a specialized camera and video hardware device in order to provide a historical documentary for her creation throughout the development process. Segments of the violin construction stages are posted on the RTP Milestone Gates for Milestone Gate I and Gate II. The maker uses the GOAT images and videos device and tools for 2D-3D conversion as well as 2D and 3D video graphics GOAT tools. NewEnt. can at this point, edit the images and embed her voice with various scenes or can send the data to a RTP Specialist to construct through the RTP Genisor system as detailed in FIG. 1.

The new maker's violin can also virtually immerse the asset in various virtual or real concert halls, a person's music room as well as contract musicians to play the instrument in a orchestra or create and record various productions using the violin. The newly created music can also be sold through the RTP platform to enhance NewEnt. revenue and unit sales. The above violin maker's asset creation is a good example of the present applications the embodiment, that by being a member of the RTP Genisor Platform, the violin maker can enrich the value of such assets by including IR images, customized audio, augmented accomplishments by other musicians, other forensics ID such as biomarkers, trackers, etc. GOAT's AI can customize and optimize the assets value over time.

The classification of asset based varies as well as the asset types of physical materials size and space depth, width, color, texture, reflexology, lumens, contours, colors, patterns and locations of the asset. The GOAT application software can compensate and adjust for each variable in order to maximize effectiveness D-3D-VR-AR-2D process.

The mathematical representation starts with 1301 (901 and 617) users and Specialists assign specific instructions using their cell phones cameras, video equipment and tools for ultra-high-definition and resolution (UHDR) 2D and 3D scanning of physical assets and objects. The physical can include any physical asset in any location and surroundings. 1313 refers to “Real Rarity” (RR) physical asset utilizing GOAT technology to identify the object in one or more locations.

The GOAT software system includes: 1316 Control Management Tools for NewEnt. Managers as a part of the 1317 RTP platform as detailed in FIG. 1. 1318 refers to parametrized models which stands for mathematical Geometric Form Conversion 1319 references the RTM Metaverse and Omniverse asset conversion from when the UHDR image is captured (image can be a 360-degree image or less), 1320 QnQiR(t) represents the number of units sold to the public and quantifies and qualifies and delineates if the user purchased the finished asset through the virtual environment (Metaverse/Omniverse) or when in “Real”/Actual physical offering state. In addition, the GOAT system analytical tools can help quantify the degree of influencing factors that made the consumer purchase the item. 1321 D is defining the parameters of the digital state and characteristic, 1322 refers to the Genisor GOAT observations and milestones. 1323 the state of the physical asset as previously described, 1324 control inputs and required actions and decisions to adjust through the P&D process, 1325 references Milestone progression during the various stages of development, (t) refers to measurable time period of development stages. 1328 references each step as it relates to the overall objectives, GOAT Management Control Software must undertake to complete the conversion of the for example, physical to metaphysical, actual physical to metaverse environments, digital to metaverse and omniverse. Enrichment of data tags to 3D assets, 3D images to holographs immersed in the metaverse, audio sounds to stereo sound in the metaverse and omniverse and any combination thereof.

In addition, 1328 delineates seven (7) process steps of enriched data conversion from observation (Step 1) to Market launch (Step 7). An embodiment of the present application as described by FIG. 13 including the preservation of the asset and utilizing periodic 2D-3D-VR-AR GOAT software to log and update the images for examination by the Specialist in order to adjust and access damage inflicted on assets over time. These data points will be entered as an important component on the Milestone Gate as represented by 1301 for Milestone Gate 1 data, inputs, Milestone data gate 2, Milestone data Gate 3 and beyond as represented by 1310. 1301 illustrates time-based progression as logged by 1301s GMP P&D Milestone progression as it relates to new development images, and digital D1, D2, D3, D4 (final launched asset) conversion over time (1301, 1303, 1304, 1305 and 1306) referencing the corresponding RTM processing system as applied. 1307 refers to the final finished product, 1302 the final RTM platform record log., 1311, the quality and quality results as previously described, 1308 metaverse (space p) sales and added project features.

1315 references the overall GOAT computing and advancement in computer conversion and algorithms technologies which can help simplify the procedure and production of 3D documentation, representation and dissemination and cultural heritage and asset integrity data including image-based photo modelling and free and open source software (FOSS) and a variety of extended applications of immersive technologies; augmented reality (AR), virtual reality (VR) and mixed reality (MxR) technologies supporting sensory experiences through a combination of real and digital content. 1313 references real rarities 2d/3d scans, coupled with 3D GOAT modeling processes to convert these images to holograms immersive virtual reality environments. The GOAT digitization process of 3D heritage assets, we can quickly find studies and research on 3D modelling and their application in ARNR image-based modelling software analyzing their performance accuracy in 3D production algorithms and scalability. Additionally, GOAT can also find several studies on approaches in application and use of VR/AR in museums and exhibitions; applied from various perspectives such as learning in the classroom group use of AR in a public space, developing virtual exhibitions, supporting interactive experiences through 3D reconstructions, and providing solutions for 3D interactive museum exhibits. GOAT and RTP provide a complete production pipeline, guiding tools for non-experts who are interested in digitizing, sharing, and viewing, using investing and buying RTP content in a mixed reality (MxR) environment.

GOAT through FIG. 13. Details the above issues and methodology solution for asset 3D digitization to MxR visualization of cultural heritage, rare and newly created high-value assets; based on proprietary and open access software and service.

In addition another embodiment of the present application includes 1321 refers to the digital state parameters characteristics where digital information can be enriched over real rarity assets. GOAT software 2d to 3d capture as well as the conversion of the asset image to virtual images and virtual asset stored on the RTP involves many steps, specific equipment, conversion software and the ability to defined boundaries (height, width, depth, color, texture, reflection ratios etc.) of asset objects of 2D images. GOAT software can facilitate deriving depth data for the 2D images associated to the user's account ID, asset identification information associated with a 2D image.

GOAT 2d software applications can assist physical asset owners Progenerate derived 3D an also be used as input to one or more augmented 3D-from-2D models digital asset for the 2D image, used by the model generation component 118 to facilitate the alignment process in association with 3D generation, and/or stored in memory (e.g., memory 122 or an external memory) for additional applications. In this manner, the method of FIG. 7 represents an example of a method comprising: determining, by a processor of a client device (the processor being implemented in a circuit), one or more regions of most interest of a plurality of mega pixelations and UHD photographs and high-quality image storage and retrieval applications and processor circuitry of a video data image based the asset classification and subclassification can utilize customized UHD 2d and 3d capture, storage and retrieval as represented by FIG. 1. Photograph and Video Coding Layer (VCL) data of a bitstream including the video data; outputting, by a processor the GOAT software application and user device. In addition, NewEnt. Managers and members and users can request a RTP Specialist's to capture the assets UHD photographs and video as well as GOAT source software, RTP processor source devices and data representing the one or more assets modifications through (t) Time.

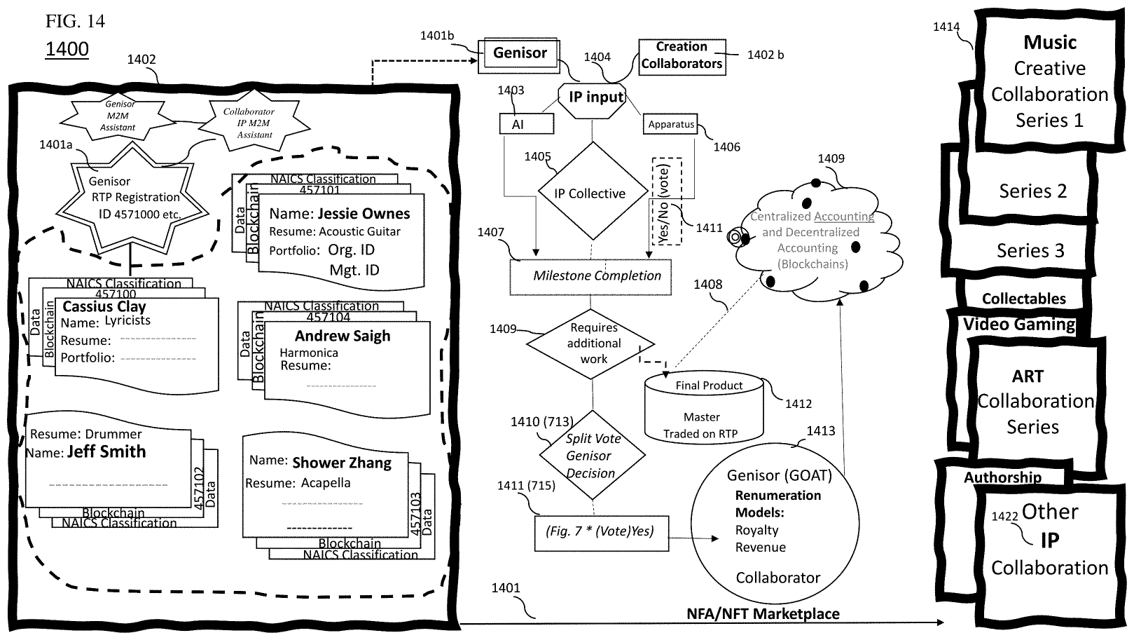

FIG. 14. 1400 Is a flow diagram of a New Enterprise (NewEnt.) Organization collaborating to create new IP music assets and IP on the RTP ecosystem with a variety of remuneration models based on production and published milestones in accordance with exemplary embodiments, exemplifies a high-level Rarity Trading Platform (RTP) and architecture for the Genisor system 1400.

The Genisor team 1414, and Auxilium product and service development process configured to gather data regarding the Genisor Team and the operational and organizational spectrum, developmental miles stones from idea generation through commercialization and market introduction as well as transactional data dissemination of selected data through one or more process servers for the final product 1412 for storage via blockchain and detailed herein and marketed on the 1401 RTP NFA/NFT marketplace 1401a, b, c, refer to the Team leader Manager and team members. The Genisor team 1414 may dynamically transfer data based on investor(s) 1406 apparatus needs and inquiries and disseminate data regarding operational milestones based on the Genisor Team investment deck, the pitch deck, the corporate mission and other go-to-market strategies and other general or specific data needed through GOAT AI 1403. The Genisor Team 1414 may form diverse types of entities such as for example a Delaware C, S corporation, Limited Liability Corporation, etc. as well as suitable SEC and International regulatory applications and agencies that enforce compliance and facilitation and rules to protect investors, orderly functioning of the securities markets and facilitate capital formation and fairness when investing in the Genisor entity or fractionally trading the products and services developed by the Genisor Team 1414. The data posts the data on the RTP 1412 and utilizes other GOAT resources through the RTP process verification such as 1409 (requires additional work) after data verification and authentication configured and added in the Blockchain. Milestone completion (t) block Gates 1407 will be entered as the team composes the melody and lyrics. In addition, GOAT tools can include historical documentation of the compensation in various stages of the conversion processes as presented and described by FIG. 13 including as referenced by 1413 royalties via GOAT rules of engagement for each team member's contribution.

Furthermore, various IP registrations 1405 can be filed with guidelines and legal assistance through the RTP network such as copyright, etc. 1406 also references the types of apparatus required by each group member such as sound editing tools and musical instruments, etc. 1409 references GOAT bidirectional communication assistance tutorials for example and other apps designed for helping musical compositions. 1402 represents the entire Genisor team and their collective ID's internal agreement and other documents as described and detailed in FIG. 15, 16, 16, 18. 1411 references the managerial decision process in this case a democratic YES/NO decision and 1410 tallies the vote as a split decision to based on a few described (entered on the Milestone Blockchain) modifications until it's a unanimous YES for production release and commercialization. 1414 references the music team deciding to compose other songs based on their first big hit. 1414 also illustrates other Genisor teams and other IP creations. 1404 represents other IP data inputs through the RTP platform and Specialists.

A scenario of the Genisor Collaboration Marketplace can be exemplified through the composition of music and audio. The Genisor develops routines that constructs the rarity IP creation or subroutines using given parameters, for a specific rock song for example, The Genisor's new rock song's construct is: GENISOR'S REQUIREMENTS (Exemplified): Applicants Required-Drummer with Drum set, Electric Guitarist, Acoustic Guitarist, Bass Guitarist, Electric Keyboardist; 1 Male Vocalist, I female Vocalist; Equipment Requirements: Microphone frequency range of 80 Hz to 15 KHz, high-definition camera; Zoom account; 5-minute sample of playtime for each musician, bio, and references for each application. All chosen musicians must be available from 3 PM EST-10 PM EST on Zoom. Statements to the team by the Genisor, such as: “All musicians in all countries welcome, music composition experience not required, talent is!” Your team's Genisor will also be posted on the blockchain.

In another embodiment, Genitors can initiate any new creation and requirements for all IP content traded on any NFT platform and the creators' certificate of ownership can be tracked on decentralized Peer-2-Peer networks. In addition, Genisors can be an individual, more than one individual, corporation (big or small), partnership, LLC, entity, organization from any region in the World. Furthermore, Genisors independently or in conjunction with NFT marketplace platforms and related entities can establish creator requirements in order to initiate creative collaboration. Moreover, one or more combination of creative teams and projects Genisors (Managers) creative roborarity AI (M2M) programs can in another embodiment be included to assist collaboration and creation. ABOUT the GENISOR (Exemplified): I have composed over 20 rock songs; 10 jazz pieces and 15 R&B music pieces and a drummer by trade. My music includes published rock songs and other music genres.

Information about the Genisors will be established on P2P networks to provide security and transparency for each creative team and a blog searches records and reports for the creative team.

Example of PROJECT OBJECTIVE & SCHEDULING: Composition Length—Min. 3:30—Max. 4:00 minutes, Start Date: January 1st—Collaboration Completion Date: January 7^{th}. January 6^{th} Final Virtual Multitrack Rehearsal: January 7^{th} will be the FINAL RECORDING and FINAL LYRICS and FINAL PUBLISHED RECORDING.

GENISOR will be responsible for final editing and mixing and deciding through the GOAT PLATFORM SOFTWARE PROGRAM individual renumeration. In another embodiment, project objectives and goals can be posted on the decentralized ledger in order to establish guidelines and collaboration. Genisors can for instance post the opening musical composition, lyrics, meaning of the song and mood the tune should connote to listeners. eBook author Genisors can outline and summarize each chapter of the book for example. Video gamer programmers, animators, and graphical designer Genisors can choreograph the gamer with notations.

Movie and video script Genisors can storyboard and outline the movie script. Graphical Topography Genisors can create virtual geographies and imaginary places with avatars and there are many other examples of creator based collaborative NFT in which the GOAT program can assist innovators, new architectural design for artists, inventors and innovative thinkers. Example of RENUMERATION & TERMS referred to as GOAT Renumeration Software (GOAT): GENISOR will receive Fifteen (15%) of all revenue received by this production. 75% will be split by the participants and fractionalized by GENISOR SOFTWARE revenues split through the final published recording (seconds chosen). 3% will pay Platform fees and an example and 7% will be budgeted for legal fees (copyright), licensing fees and promotion. GENISOR will pay for gas fees if applicable. The final recording will be sold through one or more NFT Marketplaces and through a P2P decentralized network. In addition, all recordings, applications, participating individuals and all pertinent information and data will be posted on the blockchain.

These requests can be based on a plurality of data information, such as but not limited to a profile and bio of the Genisor, description of the IP project in any level of detail or in stages, legal documents, if necessary, communication equipment needed to communicate with the team as well as requesting information regarding the collaborator's expertise and experience.

The Genisor can develop all forms of IP and can choose one or more Creation Collaborators relating to team collaborators and other information required, requested, and chosen by the Genisor from the pool of collaborator applications.

The pool of GOAT collaborators are the Genisor's selected collaborators for the project. The Genisor in this instance wants to create a new Rock & Roll song and requires 1402 a drummer, a Harmonica player an Acoustic Guitarist, a vocalist, and a Lyricist. The Genisor selects the collaborators based on the goals and objectives of the task and the experience and talent presented by the collaborators to complete the project. In this example, the Genisor requires not only a variety of musical expertise but a complete resume, past performance recording(s) samples, interviews, each member being equipped with proper equipment (communication, internet access, etc.). In addition, all creative collaborators in this case are required to prove identification and a social security number (or global equivalent) and other requirements set by the Genisor. It is obvious to anyone familiar with the art that Genisor requirements can greatly vary in scale and scope depending on the tasks and responsibilities needed to complete the task. applications.

FIG. 15. 1500 Is a flow diagram of Genisor NewEnt. organizational documents and information required by RTP members and fiduciary advisors for governance before listing in accordance with exemplary embodiments. The RTP platform required data entries on the Milestone Blockchain are exemplified by FIG. 15, (la. RTP doc. Data room series) for example determining the initial share cap can include milestone blockchain entries such as RTP registration 1501 and related information including Genisor Organizational documents, NewEnt Membership info and ID, Team membership registration(s), GOAT system training, setup and use-time. 1502, Organizational chart 1502 can include additional informational data subsets such as functional, matrix, projectized and composite methods of organizational management. 1503, can include a PDF copy of NewEnt.'s Bylaws and articles of incorporation as well as related statues templets provided by the GOAT database. 1504 represents an example NewEnt. certificate of incorporation of the and corresponding subsets of the state, country, and country jurisdiction and venue, BlueSky laws and other statues and legal templates provided by the GOAT secure database.

1505 represents shareholders agreement, convertible note agreement, debt agreements, etc. and subsets including but not limited to team member decision-making agreements, revue share and compensation, remuneration, etc., convertible notes, employee stock options and warrants and other documents. 1506 includes the list of board members as of date and all physical and (digital ID of any shareholder and member. 1507 includes an example of a PDF docs of directors, members and manager's registration bios, qualifications including applicable exemptions, shareholder convertible note documents, note holders, funding amounts and promissory notes, and other notified documents as represented by 1508. 1508 also exemplifies RTP due dates of the aforementioned documents as transcribed by the Milestone Gateway #la deliverable block(s) represented by 1509. 1510 includes digital (auto sign) or physical documents of executable contracts and acceptance of terms by NewEnt. and RTP. 1511 refers to other entries regarding NewEnt. such as executive summary, concept summary, PPM, financials etc.to determine business readiness and RTP evaluation.

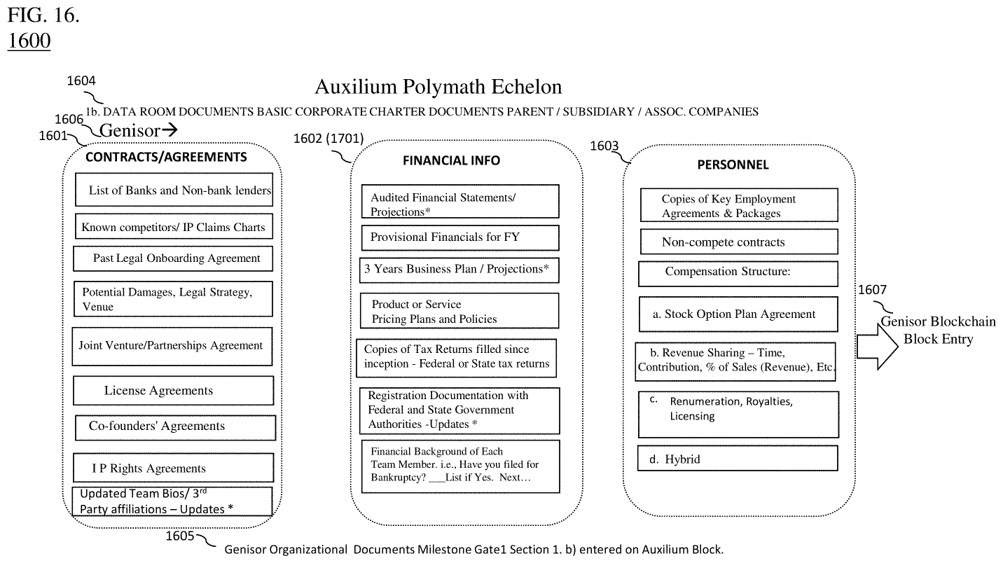

FIG. 16. 1600 Is a flow diagram of Genisor NewEnt.'s organizational documents and data such as agreements, financial information and personnel information stored via blockchain in accordance with exemplary embodiments. 1604 (1.b. Data Room documents series) references a continuation of Genisor required qualifying documentation including specific information such as: contract, agreements and affiliations: List of Banks and lenders, bank accounts, identified competitors and potential Ip infringement, past legal onboarding agreements, potential legal risks and legal strategy, JV partnership and traction, co-founder history and agreements, IP rights and additional updates for new members (bios and 3^{rd} party contractor agreements). 1602 includes financial information such as audited financial statements, provisional financials for FY, product or service pricing models and focus groups, updated registration updates, financial background questions (RTP) and answers. 1603 refers to personnel and human resource documents requirements for Milestone Gateway #1 b including key employee insurance agreements, compensation structure, stop option and other forms of remuneration (revenue sharing, profit sharing, etc., and combination hybrid) non-compete agreements and other updates. Entered on the RTP Milestone Blockchain for Gateway 1b.

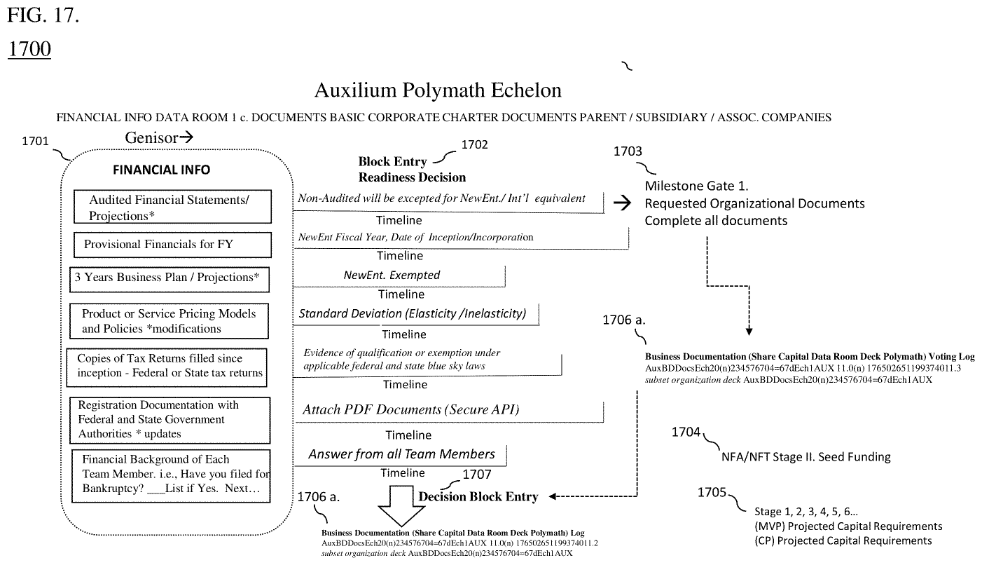

FIG. 17. 1700 Is a detailed flow diagram timeline of Genisor NewEnt.'s financial data requirements and fulfillment queries to meet initial RTP Milestone requirement and standards prior to capitalization in accordance with exemplary embodiments. 1701 (1.C. Data Room documents series) references a continuation of Genisor required qualifying documentation including specific information such as: financial information, audited statements, performs, 3-year projections, pricing model analysis, copies of tax returns, updated registration documents, and follow-up questions from RTP, 1703 signifies RTP-Milestone Blockchain Gateway 1c. data entries as each element relates to NewEnt. document release time limitation requirements and due dates prior to further opportunities of funding and leading to the next Milestone Gate “Stage II 1704 funding level. 1706 a. represents block entry codes and GOAT requirement map which can be customized in part by AI and represented by 1705 including MVP and CVP product development assistance software.

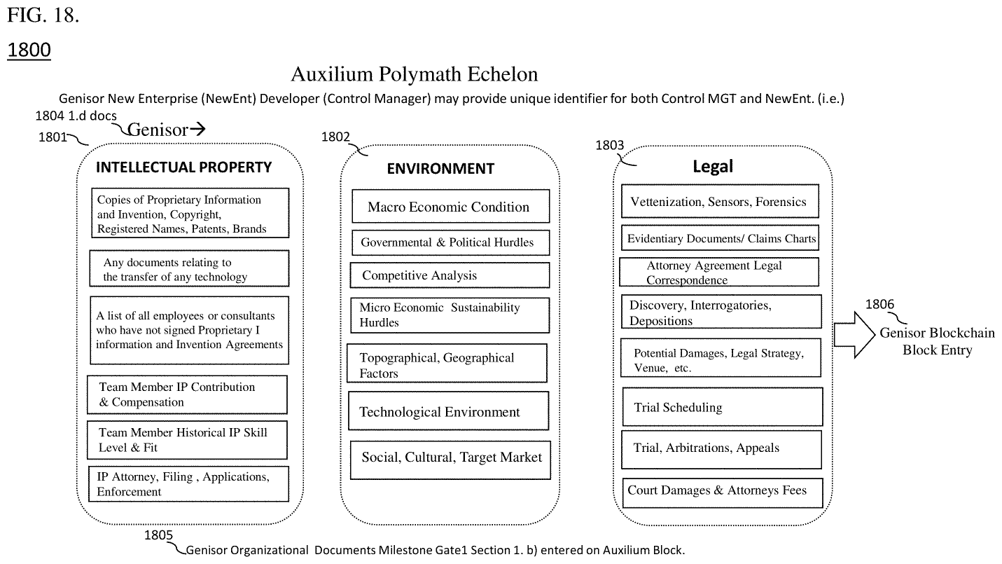

FIG. 18.1800 Is a flow diagram of Genisor NewEnt.'s organizational documents and data which can include, among others, intellectual property ownership, environmental hurdles and infringement detection, Vettenization software and legal enforcement methods, in accordance with exemplary embodiments. In other words, the organizational documents already include comprehensive information on the Genisor NewEnt.'s intellectual property assets, the market environment for that specific Genisor NewEnt business model or product such as the macro environment conditions, governmental and political hudrles, competitive analysis, and even the legal protections and framework for the Genisor NewEnt.'s business such as methods for vettenization, digital forensics and claims, enforcements and other legal strategies, correspondences with the Genisor NewEnt.'s attorneys, information on method and venues for trials and appeals to protect the Genisor NewEnt's interests, among others, 1804 represents the 1D series of Genisor deliverables entered on Milestone Blockchains. 1801 represents intellectual property applications and proprietary registered names, copyright and patent applications, secure document transfer of technology and methods, a list of signed property information, updates on compensation for new members, and attorney engagement agreements, etc. 1802 references all environmental hurdles, i.e., micro and macro-economic, governmental and political analysis, topographical, social, cultural, demographical and 1803 all legal documentation, associations with technical companies for RFID/NFC device agreements and usage manuals, evaluations of IP claims and claim charts, discovery of 3^{rd} party infringement, potential damages, trial scheduling, appeals and damage awards and attorney fee compassion.

FIG. 19. 1900 is a table and diagram of the RTP application layer including various hardware and software requirements and standards needed for the product development process layer and product development in accordance with exemplary embodiments. 1901 references the RTP application layer that can include various hardware, software and firmware access depending on the product and services being developed. The product development and service application layer also can include GOAT software requirements and guidelines suggestions through AI as well as usage manuals as well as equipment as software based on milestone goals and objectives.

In general, the service layer referred to in 1903 represents components of the Genisor Auxilium Operational toolkits and software its purpose is to segment all kinds of ecosystem data application layer, where developers are key figures and utilize its services to develop applications, products new creations.

1911 represents the secure communication layer where data and information networks as well as 3^{rd} party API interact. 1904 references another example process of the product and service development layers and pertaining tools based and adjusted to a 1905 NewEnt. Core competency and skill level of the assembled team members. In other words, the Genisor GOAT AI system can fill the talent void with another Specialist for example required for a successful outcome.

The Process layer can also include 1906 customer target analysis, 1905 product and concept idea development strategies, 1907 idea screening, 1909 product prototyping tools and functional analysis upon completion and other data relative to successful outcomes transcribed by Milestone deliverable completion. 1908 exemplifies capitalization and funding availability based on successful prototype completion. In addition, the GOAT's Core Layer includes various instructions are processed (which can be written only in two programming languages—Solidity and Java). Principle of operation: the core layer computes instructions, processes them, and sends them to the to and from one or more virtual machines, where the logic is applied, and dApps are executed.

FIG. 20. 2000 Is a diagram of general milestone capitalization process based on objectives and tasks (Milestone Gates) levels which the Genisor NewEnt. must achieve prior to gaining access to corresponding tiered funding in accordance with exemplary embodiments. 2001 references one of the most important aspects on the RTP system, Capitalization and funding. The present application details in many aforementioned figures and descriptions, “Milestone gate(s), Milestone Paths, Milestone gateways as it relates to milestone the progress and deliverables of product and service development referenced by 2003 includes various stages of capitalization and funding based on the achievement of milestone deliverables.

Genisor project capital 2004 can be greatly streamlined and made more efficient through the methods, systems and standards described by GOAT 2001 and the socialization and discovery of the development referred in 2010 and utilized by the RTP platform 2009. Legal guidelines and options, oversight and rules are also a strong factor to investors as referenced by 2202. 2002a refers to the close collaborative communication and skill sets team members must have to accomplish the milestones from start to finish the marketable product 2002c. 2006 refers to the customizable nature of GOAT and the delineation of certain specific tasks and applications adopted by NewEnt. Managers for specific tasks, 2006 recaps and includes all classifications of assets, 2007 advanced tools for scheduling and milestone work assignments and auditing accounting verification during any and all steps, if required, and 2011 assistance from other ancillary software apps capitalization methods based and 2012 include all types of private and public offerings. And best of all, 2005 refers to the RTP system enabling the New Enterprise to be totally autonomous if in their best interests to lower risks through the inventions and to create jobs and stability.

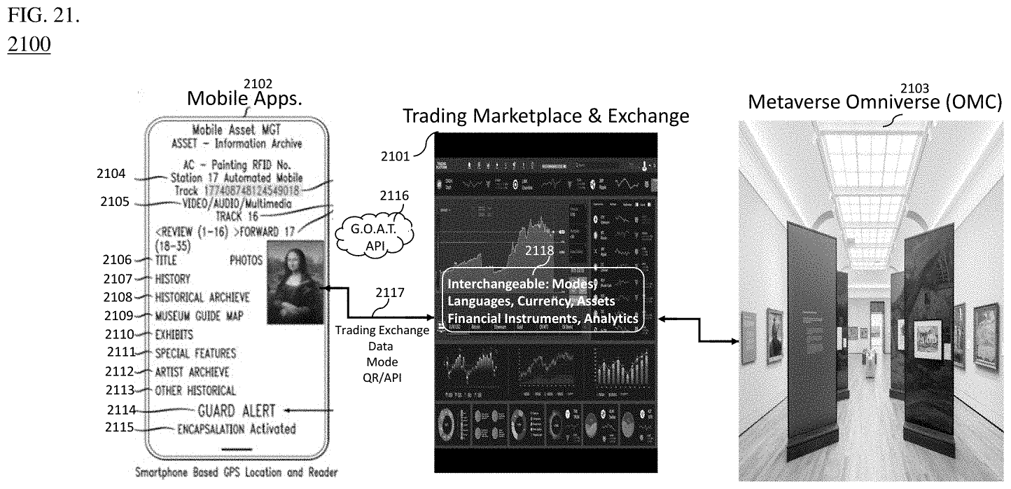

FIG. 21. 2100 is a graph that exemplifies a Non-Fungible-Assets (NFA) and Non fungible Token (NFT) financial data on various mobile apps and devices with interchangeable Metaverse and Omniverse trading modes. 2102 references and exemplifies one or more assets displayed and accessible on smart mobile devices through various applications and mobile platforms. 2101 exemplifies the trading of RTP assets on the mobile platform and recorded on the milestone blockchain, 2104, 2105, 2006, 2107, 2108, 2109, 2110, 2111, 2112, 2113, 2114, 2115 and others include specific information regarding the chosen (on RTM browser query). In addition, 20103 includes information that can be accessed as described by (2104, 2105, 2006, 2107, 2108, 2109, 2110, 2111, 2112, 2113, 2114, 2115) on the Metaverse and Omniverse mode (OMC) through one or means, one or APIs. In other words, the RTP mobile system can interchangeably change viewing modes from both “real” and “actual “trading displays to “Virtual” Metaverse/Omniverse trading displays or both through the RTP mobile system.

FIG. 22. Is a diagram that demonstrates the Genisor Platform Milestone-Based Concentric Product Progression from concept through Product Introduction and Resulting Valuation in accordance with exemplary embodiments. FIG. 22 is continuation of the Milestone Gate examples in FIG. 6. 2201, 2202, 2203, 2204, 2205, 2206, 2207 represent the history of NewEnt. “Shower Power Shampoo”, LLC as well as various milestone deliverables entered and accessed through the Milestone blockchain. The Shower Power Shampoo company accomplishments and deliverables entered and accessed on the Milestone Blockchain is represented by the series of progressive entries from 2201a 2201 b, 2201c.—Milestone Blockchain programing data sets, and subsequent Milestone data pertaining to each Milestone Gate (2, 3, 4, 5, 6, 7) stage period. (2202a, 2202b. 2203a &b, 3304a, 2205a, 2206a, 2207a and 2208a) represents additional data timeline entries for various milestone deliverables required for each Milestone gate such as for example Market Survey completion deliverables 2202a for Milestone Gate 2 and 2203b referencing Minimum Viable Product Completion.

Furthermore, FIG. 22. shows Shower Power Shampoo, LLC receiving various levels of funding for every Milestone Date completion Gate 1. $75,000, Gate 2. $250,000, Gate 3. $3,000,000, Gate 4. $7,500,000, Gate 5 $12,500,000, Gate 6 $17,500,000 and Gate 7 showing Shower Power Shampoo after the IPO's valuation at $150,000,000 USD. This is illustrative of the GOAT “automating” the process for vetting a startup with a pre-determined set of milestones so that it may gain access to capitalization and funding. It eliminates the subjectivity that underlies capital-raising rounds by providing a system-tracked set of Milestones that are measurable and tracked in the GOAT.

Other GENISOR embodiments are based collaborative creator listed on one or more Rarity Trading Platforms (RTF) and sold through a plurality of customized methods including fractionalization or through wholistic ownership of shares, stakes, or units of ownership etc. This customization includes but is not limited to the tokenization and fractionization of rarity assets for both intangible and tangible assets.

In an embodiment, the collective artistic IP creator and generator (GENISOR) are considered collaborative managers for the creative process and projects to be sold through auctions, markets, purchased wholistically or fragmentally throughout the collaboration process. Managers are defined for the purpose of this invention as people or M2M responsible in whole or in part for controlling or administering all or part of a project, collaboration of peers herein referred to as “Collaborators”, for a company, organization or project group or a one or a series of collaborations for the purpose of developing new rarity creations. In addition, the Genisor Manager assists and aids to control all activities, business dealings, and other aspects of the group of i.e., musicians, artist, designers, scientists, sports memorabilia and collectibles, athletes, financial services, news and media, collective transactions, valuations, trading, royalties and all and every business and creative expression, facet of the creative process for all NFT applications, DeFi, DApps, platforms, etc.

Another embodiment describes a processor-implemented method for the creation of rarities and royalty-based ownership through on or more NFT platforms and based on the ledger and fractional trade and transfer, tracking of intangibles as well as tangible assets using P2P decentralized blockchain technology. Another embodiment includes methods to generate a root node associated with an intangible/tangible asset via a processor for Genisor and Collaborating Creators to track all pertinent information and data related to each contributor and subsequent royalty due through the fractionalized P2P royalty-based network (Rarity Trading Platform) and GOAT Renumeration Software (GOAT).

One embodiment includes GOAT System Mathematical Fractional Compensation and Royalties (MFCR) programming that can be based on a plurality of variables when royalties are distributed to content creators depending on their contributions and various considerations that will decide their corresponding entitlements to shares of the royalties. This includes but is not limited to: Creator Royalties for creators based on social media to help rank creative value on a micro bases, ranking the creator's value of the song melody, instrumentals, lyrics, etc. In addition, in another embodiment, social media can help alter royalties based on popularity and views. This will enable Creator Royalties based on pre-established compensation and standards established by the GENISOR. For example, royalties can depend on tracking time of programing video games used in gaming, number of words written, how long (quantify the seconds of the song) the acoustic guitar used, etc., VIP membership Royalties can be based on club style memberships and first rights to an IP creation to obtain a discount and perks as differentiated from non-members. Creator Royalties can be based on flat fees for each creator that can be fractionalized through the NFA/NFTs. Royalties can be based on prepayment and commissions for various GENISOR teams. Creator Royalties can be based on tiered compensation to creators after COGS, taxes, net, etc. Creator Royalties can be based on NFT Platform rules for each IP rarity classification to preserve the original state of data inputs while adapting to changing circumstances, user preferences, and emerging technological capabilities, Creator Royalties can be based on a collaborative team for one project or a series of projects. Creator Royalties can depend on values are enhanced through and by celebrities. In this case, the Creator Royalties will depend on the fame and broad public recognition of an individual or group because of the attention given to them by mass media. For example, an original IP creation through the RTP (NFT) platform could be acquired by a celebrity which will raise the value of future IP from the same Genisor and collaborative team. Creator Royalties can be bundled with other products and services or a series of products and services. Creator-subscriber based royalties, split fractionally, Creator royalties can also be fractionalized or sold as a whole through an auction or bidding. Advertising revenue royalties can also split fractionally and allocated based on some defined standards. The Mathematical Fractional Compensation and Royalties (MFCR) programming by a set of definable standards, helps quantify the value that each creator brings to an asset or creation and the corresponding royalties that must be due to them. NFT Customization and combination of one or more components and elements as previously described.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

While the exemplary embodiments of the present invention have been described with respect to processing blocks in a software program, including possible implementation as a digital signal processor, micro-controller, or general-purpose computer, the present invention is not so limited. As would be apparent to one skilled in the art in appreciation of the model, various functions of software may also be implemented as processes of circuits. Such circuits may be employed in, for example, a single integrated circuit, a multi-chip module, a single card, or a multi-card circuit pack.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

It is to be appreciated and understood that components, as described with regard to a particular system or method, can include the same or similar functionality as respective components (e.g. respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses.” and the like are used in the detailed description, claims, appendices and drawings such terms are intended to be inclusive in a manner similar to the term “comprising” as “comprising” is interpreted when employed as a transitional word in a claim.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03 and its global equivalent.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports may be referred to by the same name and are interchangeable for purposes here.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. A method for organizing and managing the operations and expectations of a productive organization, said method comprising:
a. setting the goals of the organization;
b. establishing the intended structure of the organization, including personnel roles, given said goals;
c. incorporation and recording of said goals and said structure into an online blockchain network, said blockchain network integrated into a broader peer-to-peer and machine-to-machine network of other organizations and entities;
d. determining the skills and knowledge required to reach said goals per said intended structure;
e. identifying skill or knowledge gaps in available personnel against said required skills and knowledge; and,
f. drawing on the skills and knowledge known to exist in other entities or organizations to compensate for said identified skill and knowledge gaps.

2. A trading platform that makes use of the online blockchain network of claim 1 to enable valuation, identification, authentication, fractionation, and trading of assets, including original assets and digital twins, throughout said blockchain network.
